(19) United States
(12) Patent Application Publication
(10) Pub. No.: US 2023/0261717 A1
(43) Pub. Date: Aug. 17, 2023

(54) SATELLITE TRACKING RELATED METHODS

(71) Applicant: QUALCOMM INCORPORATED, San Diego, CA (US)

(72) Inventors: Liangping MA, San Diego, CA (US); Xiao Feng WANG, San Diego, CA (US); Jun MA, San Diego, CA (US); Ayan SENGUPTA, San Diego, CA (US); Bharat SHRESTHA, San Diego, CA (US); Alberto RICO ALVARINO, San Diego, CA (US); Peter GAAL, San Diego, CA (US); Umesh PHUYAL, San Diego, CA (US); Qiang WU, San Diego, CA (US); Yiqing CAO, Beijing (CN)

(21) Appl. No.: 18/003,584

(22) PCT Filed: Sep. 2, 2020
(86) PCT No.: PCT/CN2020/113025

§ 371 Date: Dec. 28, 2022

(51) Int. Cl. H04B 7/06; H04W 72/51; H04W 72/21

(52) U.S. Cl. CPC H04B 7/0628; H04W 72/51; H04W 72/21

(57) ABSTRACT

Methods, systems, and devices for wireless communications are described Generally, the described techniques provide for a user equipment (UE) to perform a beam switching operation from a current beam to a target beam based on a beam switching duration. The UE may transmit a capability report that may include an antenna pointing capability, a list of one or more detailed capabilities, or both to another device, such as a network entity (e.g., a satellite). The UE may perform the beam switching operation based on the capability report. The UE may perform a random access procedure as part of a change of association operation. The UE may receive a control message from the other device, which may be the network entity, that includes an identity of a target network entity, one or more resources for the random access procedure, an indication of the beam switching duration, or any combination.

### CROSS REFERENCE

The present Application is a 371 national stage filing of International PCT Application No. PCT/CN2020/113025 by MA et al. entitled “SATELLITE TRACKING RELATED METHODS,” filed 2 Sep. 2020, which is assigned to the assignee hereof, and which is expressly incorporated by reference in its entirety herein.

### FIELD OF TECHNOLOGY

The following relates to wireless communications, including satellite tracking related methods.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support device (e.g., satellite) tracking related methods. Generally, the described techniques provide for a user equipment (UE) to perform a beam switching operation from a current beam to a target beam based on a beam switching duration, which may be the time it takes for the UE to move an antenna from a current beam to a target beam. In some cases, the UE may transmit a capability report that may include an antenna pointing capability, a list of one or more detailed capabilities, or both to another device, such as a network entity (e.g., a satellite in a non-terrestrial network). The UE may perform the beam switching operation based on the capability report. In some examples, the UE may perform a random access procedure as part of a change of association operation. The UE may receive a control message from the other device, which may be the network entity, that includes an identity of a target network entity, one or more resources for the random access procedure, an indication of the beam switching duration, or any combination. The UE may transmit a random access preamble to a device, such as a network entity, using a target beam based on moving the antenna during the beam switching duration.

In some cases, the UE may communicate with the device (e.g., network entity) according to a discontinuous reception (DRX) cycle configuration. In some cases, the configuration may include a timer corresponding to an off duration of the DRX operation. The UE may perform a beam switching procedure from a current beam to a target beam based on the timer expiring (e.g., during an on duration of the DRX cycle). In some examples, the UE may perform a cell reselection procedure based on an antenna pointing capability and the state of the UE or the one or more candidate cells. For example, the UE may reselect a cell from multiple candidate cells associated with one or more devices, such as candidate network entities, based on one or more factors related to the devices (e.g., candidate network entities) and the antenna of the UE. In some cases, a device, such as a base station or a current network entity, may transmit information about the incoming candidate network entities to the UE. The UE may perform a cell reselection from a current beam associated with a cell from a current network entity to a target beam associated with a candidate cell from a candidate network entity.

A method of wireless communications at a UE is described. The method may include determining a capability of the UE associated with moving an antenna during a duration from a first direction corresponding to a first beam for communicating with a network entity to a second direction corresponding to a second beam for communicating, transmitting, to the network entity, an indication of the capability associated with moving the antenna during the duration from the first direction to the second direction, and moving the antenna, during the duration, from the first direction to the second direction based on transmitting the indication of the capability.

An apparatus for wireless communications at a UE is described. The apparatus may include a processor, memory coupled with the processor, and instructions stored in the memory. The instructions may be executable by the processor to cause the apparatus to determine a capability of the UE associated with moving an antenna during a duration from a first direction corresponding to a first beam for communicating with a network entity to a second direction corresponding to a second beam for communicating, transmit, to the network entity, an indication of the capability associated with moving the antenna during the duration from the first direction to the second direction, and move the antenna, during the duration, from the first direction to the second direction based on transmitting the indication of the capability.

Another apparatus for wireless communications at a UE is described. The apparatus may include means for determining a capability of the UE associated with moving an antenna during a duration from a first direction corresponding to a first beam for communicating with a network entity to a second direction corresponding to a second beam for communicating, transmitting, to the network entity, an indication of the capability associated with moving the antenna during the duration from the first direction to the second direction, and moving the antenna, during the duration, from the first direction to the second direction based on transmitting the indication of the capability.

A non-transitory computer-readable medium storing code for wireless communications at a UE is described. The code may include instructions executable by a processor to determine a capability of the UE associated with moving an antenna during a duration from a first direction corresponding to a first beam for communicating with a network entity to a second direction corresponding to a second beam for communicating, transmit, to the network entity, an indication of the capability associated with moving the antenna during the duration from the first direction to the second direction, and move the antenna, during the duration, from the first direction to the second direction based on transmitting the indication of the capability.

In some examples of the method, apparatuses, and non-transitory computer-readable medium described herein, determining the capability of the UE associated with moving the antenna may include operations, features, means, or instructions for receiving an indication corresponding to the duration, the duration associated with a duration for the UE to steer the antenna based on a difference in one or more degrees between a first angle corresponding to the first direction and a second angle corresponding to the second direction.

In some examples of the method, apparatuses, and non-transitory computer-readable medium described herein, determining the capability of the UE associated with moving the antenna may include operations, features, means, or instructions for determining an antenna type associated with the antenna, a number of antennas at the UE, a continuous tracking mode associated with the antenna, a step-wise tracking mode associated with the antenna, or any combination thereof.

Some examples of the method, apparatuses, and non-transitory computer-readable medium described herein may further include operations, features, means, or instructions for determining to perform a change of association procedure from the network entity to a target network entity, where the second beam may be for communicating with the target network entity, and communicating with the target network entity based on moving the antenna from the first direction to the second direction.

In some examples of the method, apparatuses, and non-transitory computer-readable medium described herein, the change of association procedure may be a handover between two cells.

In some examples of the method, apparatuses, and non-transitory computer-readable medium described herein, the change of association procedure may be a beam switching operation within a same cell.

In some examples of the method, apparatuses, and non-transitory computer-readable medium described herein, the antenna may be an active electronically scanned array or a mechanical motor steered antenna.

In some examples of the method, apparatuses, and non-transitory computer-readable medium described herein, the UE and the network entity may be associated with a non-terrestrial network, and where the network entity may be a satellite.

A method of wireless communications at a UE is described. The method may include receiving, from a network entity, a control message, the control message including an indication of one or more resources to use for a random access preamble associated with a random access procedure, determining, based on receiving the control message, a duration during which an antenna of the UE is to move from a first direction corresponding to a first beam for communicating with the network entity to a second direction corresponding to a second beam for communicating, and transmitting, after the duration, the random access preamble using the one or more resources.

An apparatus for wireless communications at a UE is described. The apparatus may include a processor, memory coupled with the processor, and instructions stored in the memory. The instructions may be executable by the processor to cause the apparatus to receive, from a network entity, a control message, the control message including an indication of one or more resources to use for a random access preamble associated with a random access procedure, determine, based on receiving the control message, a duration during which an antenna of the UE is to move from a first direction corresponding to a first beam for communicating with the network entity to a second direction corresponding to a second beam for communicating, and transmit, after the duration, the random access preamble using the one or more resources.

Another apparatus for wireless communications at a UE is described. The apparatus may include means for receiving, from a network entity, a control message, the control message including an indication of one or more resources to use for a random access preamble associated with a random access procedure, determining, based on receiving the control message, a duration during which an antenna of the UE is to move from a first direction corresponding to a first beam for communicating with the network entity to a second direction corresponding to a second beam for communicating, and transmitting, after the duration, the random access preamble using the one or more resources.

A non-transitory computer-readable medium storing code for wireless communications at a UE is described. The code may include instructions executable by a processor to receive, from a network entity, a control message, the control message including an indication of one or more resources to use for a random access preamble associated with a random access procedure, determine, based on receiving the control message, a duration during which an antenna of the UE is to move from a first direction corresponding to a first beam for communicating with the network entity to a second direction corresponding to a second beam for communicating, and transmit, after the duration, the random access preamble using the one or more resources.

Some examples of the method, apparatuses, and non-transitory computer-readable medium described herein may further include operations, features, means, or instructions for determining to perform a change of association procedure from the network entity to a target network entity, where the second beam may be for communicating with the target network entity.

In some examples of the method, apparatuses, and non-transitory computer-readable medium described herein, the change of association procedure may be a handover between two cells.

In some examples of the method, apparatuses, and non-transitory computer-readable medium described herein, the change of association procedure may be a beam switching operation within a same cell.

In some examples of the method, apparatuses, and non-transitory computer-readable medium described herein, receiving the control message may include operations, features, means, or instructions for receiving an indication of the target network entity, the indication including location information of the target network entity, an identifier corresponding to the target network entity, or both.

In some examples of the method, apparatuses, and non-transitory computer-readable medium described herein, transmitting the random access preamble may include operations, features, means, or instructions for transmitting the random access preamble to the target network entity as part of the handover procedure, where the second beam may be for communicating with the target network entity.

Some examples of the method, apparatuses, and non-transitory computer-readable medium described herein may further include operations, features, means, or instructions for receiving, from the network entity, a downlink control channel order, the downlink control channel order including an indication of the duration, where transmitting the random access preamble after the duration may be based on receiving the downlink control channel order.

Some examples of the method, apparatuses, and non-transitory computer-readable medium described herein may further include operations, features, means, or instructions for receiving a downlink control information (DCI) message, a medium access control-control element (MAC-CE), or both, the DCI message, the MAC-CE, or both including an index corresponding to the random access preamble, an indication of one or more random access occasions, or both.

In some examples of the method, apparatuses, and non-transitory computer-readable medium described herein, transmitting the random access preamble may include operations, features, means, or instructions for determining an additional duration, the additional duration including an uplink channel preparation time, a BWP switching duration, an operational frequency range duration, or any combination thereof, and transmitting the random access preamble based on the duration and the additional duration.

Some examples of the method, apparatuses, and non-transitory computer-readable medium described herein may further include operations, features, means, or instructions for determining a given duration based on a capability of the UE to move the antenna of the UE and transmit the random access preamble concurrently, and transmitting the random access preamble after the given duration, where the given duration corresponds to the shorter of the duration and the additional duration.

Some examples of the method, apparatuses, and non-transitory computer-readable medium described herein may further include operations, features, means, or instructions for transmitting the random access preamble after the duration and the additional duration.

In some examples of the method, apparatuses, and non-transitory computer-readable medium described herein, receiving the control message may include operations, features, means, or instructions for receiving an indication of the duration, the duration corresponding to a handover outage time, a duration for the UE to apply frequency compensation, a duration for frequency retuning, or any combination thereof.

In some examples of the method, apparatuses, and non-transitory computer-readable medium described herein, the indication may be a field in a radio resource control (RRC) message.

Some examples of the method, apparatuses, and non-transitory computer-readable medium described herein may further include operations, features, means, or instructions for initiating a timer based on receiving the indication, the timer duration corresponding to the duration, and transmitting the random access preamble based on the timer duration.

In some examples of the method, apparatuses, and non-transitory computer-readable medium described herein, the control message may be an RRC message.

Some examples of the method, apparatuses, and non-transitory computer-readable medium described herein may further include operations, features, means, or instructions for determining the duration based on a handover outage time, a duration for the UE to apply frequency compensation, a duration for frequency retuning, or any combination thereof.

Some examples of the method, apparatuses, and non-transitory computer-readable medium described herein may further include operations, features, means, or instructions for determining the handover outage time based on ephemeris information associated with one or more network entities, a capability of the UE associated with moving the antenna, or any combination thereof.

In some examples of the method, apparatuses, and non-transitory computer-readable medium described herein, receiving the control message including the indication of one or more resources may include operations, features, means, or instructions for receiving an index corresponding to the random access preamble, one or more random access occasions for transmitting the random access preamble, or any combination thereof.

In some examples of the method, apparatuses, and non-transitory computer-readable medium described herein, the UE and the network entity may be associated with a non-terrestrial network, and where the network entity may be a satellite.

A method of wireless communications at a UE is described. The method may include receiving, from a network entity, a control message, the control message including an indication of a pattern of DRX cycles for a first beam for communicating with the network entity, each DRX cycle including an active reception duration and an inactive reception duration, moving an antenna of the UE from a first direction corresponding to the first beam to a second direction corresponding to a second beam for communicating, where the first beam is associated with a first cell and the second beam is associated with a second cell, and communicating with the network entity during an active reception duration of at least one DRX cycle based on moving the antenna from the first direction to the second direction.

An apparatus for wireless communications at a UE is described. The apparatus may include a processor, memory coupled with the processor, and instructions stored in the memory. The instructions may be executable by the processor to cause the apparatus to receive, from a network entity, a control message, the control message including an indication of a pattern of DRX cycles for a first beam for communicating with the network entity, each DRX cycle including an active reception duration and an inactive reception duration, move an antenna of the UE from a first direction corresponding to the first beam to a second direction corresponding to a second beam for communicating, where the first beam is associated with a first cell and the second beam is associated with a second cell, and communicate with the network entity during an active reception duration of at least one DRX cycle based on moving the antenna from the first direction to the second direction.

Another apparatus for wireless communications at a UE is described. The apparatus may include means for receiving, from a network entity, a control message, the control message including an indication of a pattern of DRX cycles for a first beam for communicating with the network entity, each DRX cycle including an active reception duration and an inactive reception duration, moving an antenna of the UE from a first direction corresponding to the first beam to a second direction corresponding to a second beam for communicating, where the first beam is associated with a first cell and the second beam is associated with a second cell, and communicating with the network entity during an active reception duration of at least one DRX cycle based on moving the antenna from the first direction to the second direction.

A non-transitory computer-readable medium storing code for wireless communications at a UE is described. The code may include instructions executable by a processor to receive, from a network entity, a control message, the control message including an indication of a pattern of DRX cycles for a first beam for communicating with the network entity, each DRX cycle including an active reception duration and an inactive reception duration, move an antenna of the UE from a first direction corresponding to the first beam to a second direction corresponding to a second beam for communicating, where the first beam is associated with a first cell and the second beam is associated with a second cell, and communicate with the network entity during an active reception duration of at least one DRX cycle based on moving the antenna from the first direction to the second direction.

In some examples of the method, apparatuses, and non-transitory computer-readable medium described herein, the control message may include operations, features, means, or instructions for activating the timer at a start of an inactive reception duration of the at least one DRX cycle based on receiving the indication, waking up at the start of the active reception duration of the at least one DRX cycle based on the timer expiring, and receiving a beam switching command, where moving the antenna from the first direction to the second direction may be based on receiving the beam switching command.

Some examples of the method, apparatuses, and non-transitory computer-readable medium described herein may further include operations, features, means, or instructions for transmitting, to the network entity, a feedback message corresponding to receiving the beam switching command.

Some examples of the method, apparatuses, and non-transitory computer-readable medium described herein may further include operations, features, means, or instructions for performing a beam switching operation from a first BWP associated with the first beam to a second BWP associated with the second beam based on receiving the beam switching command.

In some examples of the method, apparatuses, and non-transitory computer-readable medium described herein, the timer corresponds to a handover outage time, a duration for the UE to apply frequency compensation, a duration for frequency retuning, or any combination thereof.

In some examples of the method, apparatuses, and non-transitory computer-readable medium described herein, the control message may include operations, features, means, or instructions for activating the timer after receiving the control message, waking up based on the timer expiring, and determining to perform a change of association procedure based on the first cell being different than the second cell.

Some examples of the method, apparatuses, and non-transitory computer-readable medium described herein may further include operations, features, means, or instructions for transmitting, to a network entity associated with the second beam, an indication of the change of associated procedure, where the indication includes a random access preamble, a scheduling request, or both.

In some examples of the method, apparatuses, and non-transitory computer-readable medium described herein, the change of association procedure may be a handover procedure from a current cell associated with the network entity to a target cell associated with a target network entity, where the second beam may be for communicating with the target network entity.

In some examples of the method, apparatuses, and non-transitory computer-readable medium described herein, the timer corresponds to a duration for the UE to enter a coverage area associated with the second beam, a handover outage time, a duration for the UE to apply frequency compensation, a duration for frequency retuning, or any combination thereof.

In some examples of the method, apparatuses, and non-transitory computer-readable medium described herein, the control message includes an indication of the active reception duration, the inactive reception duration, a DRX inactivity timer, a DRX slot offset, a DRX long cycle, a start offset of the DRX long cycle, a DRX short cycle, a DRX short cycle timer, an initial BWP configuration of the second beam, or any combination thereof.

In some examples of the method, apparatuses, and non-transitory computer-readable medium described herein, the UE and the network entity may be associated with a non-terrestrial network, and where the network entity may be a satellite.

A method of wireless communications at a UE is described. The method may include identifying information corresponding to one or more of a set of cells, the set of cells corresponding to one or more candidate network entities, the information associated with a capability of the UE corresponding to moving an antenna during a duration and a state of the UE, selecting, for a cell reselection procedure from a current cell and based on the information, a target cell from the set of cells, the target cell associated with a candidate network entity of the one or more candidate network entities, performing the cell reselection procedure to the target cell based on selecting the target cell from the set of cells, and communicating with the candidate network entity based on the cell reselection procedure.

An apparatus for wireless communications at a UE is described. The apparatus may include a processor, memory coupled with the processor, and instructions stored in the memory. The instructions may be executable by the processor to cause the apparatus to identify information corresponding to one or more of a set of cells, the set of cells corresponding to one or more candidate network entities, the information associated with a capability of the UE corresponding to moving an antenna during a duration and a state of the UE, select, for a cell reselection procedure from a current cell and based on the information, a target cell from the set of cells, the target cell associated with a candidate network entity of the one or more candidate network entities, perform the cell reselection procedure to the target cell based on selecting the target cell from the set of cells, and communicate with the candidate network entity based on the cell reselection procedure.

Another apparatus for wireless communications at a UE is described. The apparatus may include means for identifying information corresponding to one or more of a set of cells, the set of cells corresponding to one or more candidate network entities, the information associated with a capability of the UE corresponding to moving an antenna during a duration and a state of the UE, selecting, for a cell reselection procedure from a current cell and based on the information, a target cell from the set of cells, the target cell associated with a candidate network entity of the one or more candidate network entities, performing the cell reselection procedure to the target cell based on selecting the target cell from the set of cells, and communicating with the candidate network entity based on the cell reselection procedure.

A non-transitory computer-readable medium storing code for wireless communications at a UE is described. The code may include instructions executable by a processor to identify information corresponding to one or more of a set of cells, the set of cells corresponding to one or more candidate network entities, the information associated with a capability of the UE corresponding to moving an antenna during a duration and a state of the UE, select, for a cell reselection procedure from a current cell and based on the information, a target cell from the set of cells, the target cell associated with a candidate network entity of the one or more candidate network entities, perform the cell reselection procedure to the target cell based on selecting the target cell from the set of cells, and communicate with the candidate network entity based on the cell reselection procedure.

Some examples of the method, apparatuses, and non-transitory computer-readable medium described herein may further include operations, features, means, or instructions for receiving, from a network entity, an indication of a cell identifier for each cell of the set of cells, location information corresponding to the one or more candidate network entities, relative speed information corresponding to the one or more candidate network entities, orbital information corresponding to the one or more candidate network entities, a random access preamble for each cell of the set of cells, a priority associated with the one or more candidate network entities, or any combination thereof, where identifying the information may be based on the receiving.

Some examples of the method, apparatuses, and non-transitory computer-readable medium described herein may further include operations, features, means, or instructions for determining a capability of the UE to perform the cell reselection procedure from the current cell to the target cell, where performing the cell reselection procedure may be based on determining the capability of the UE to perform the cell reselection procedure.

In some examples of the method, apparatuses, and non-transitory computer-readable medium described herein, the information includes location information associated with each candidate network entity of the one or more candidate network entities, a difference measured in angles corresponding to moving the antenna from a first direction associated with the current cell to a second direction associated with the target cell, a speed corresponding to moving the antenna from the first direction to the second direction, an indication of a cell identifier for each cell of the set of cells, a priority associated with the one or more candidate network entities, a duration corresponding to a quality of service requirement at the UE, one or more measurements corresponding to a link quality between the UE and the one or more candidate network entities, or any combination thereof.

A method of wireless communications at a first network entity is described. The method may include receiving, from a UE, an indication of a capability of the UE associated with moving an antenna during a duration from a first direction corresponding to a first beam for communicating with a second network entity to a second direction corresponding to a second beam for communicating with the first network entity and communicating with the UE using the second beam based on the UE moving the antenna, during the duration, from the first direction to the second direction based on the capability.

An apparatus for wireless communications at a first network entity is described. The apparatus may include a processor, memory coupled with the processor, and instructions stored in the memory. The instructions may be executable by the processor to cause the apparatus to receive, from a UE, an indication of a capability of the UE associated with moving an antenna during a duration from a first direction corresponding to a first beam for communicating with a second network entity to a second direction corresponding to a second beam for communicating with the first network entity and communicate with the UE using the second beam based on the UE moving the antenna, during the duration, from the first direction to the second direction based on the capability.

Another apparatus for wireless communications at a first network entity is described. The apparatus may include means for receiving, from a UE, an indication of a capability of the UE associated with moving an antenna during a duration from a first direction corresponding to a first beam for communicating with a second network entity to a second direction corresponding to a second beam for communicating with the first network entity and communicating with the UE using the second beam based on the UE moving the antenna, during the duration, from the first direction to the second direction based on the capability.

A non-transitory computer-readable medium storing code for wireless communications at a first network entity is described. The code may include instructions executable by a processor to receive, from a UE, an indication of a capability of the UE associated with moving an antenna during a duration from a first direction corresponding to a first beam for communicating with a second network entity to a second direction corresponding to a second beam for communicating with the first network entity and communicate with the UE using the second beam based on the UE moving the antenna, during the duration, from the first direction to the second direction based on the capability.

Some examples of the method, apparatuses, and non-transitory computer-readable medium described herein may further include operations, features, means, or instructions for transmitting, to the UE, an indicator corresponding to the duration, the duration associated with a duration for the UE to steer the antenna based on a difference in degrees between a first angle corresponding to the first direction and a second angle corresponding to the second direction.

In some examples of the method, apparatuses, and non-transitory computer-readable medium described herein, the first network entity may be a target network entity in a change of association procedure.

In some examples of the method, apparatuses, and non-transitory computer-readable medium described herein, the change of association procedure may be a handover between two cells.

In some examples of the method, apparatuses, and non-transitory computer-readable medium described herein, the change of association procedure may be a beam switching operation within a same cell.

In some examples of the method, apparatuses, and non-transitory computer-readable medium described herein, the antenna may be an active electronically scanned array or a mechanical motor steered antenna.

In some examples of the method, apparatuses, and non-transitory computer-readable medium described herein, the UE and the first network entity may be associated with a non-terrestrial network, and where the network entity may be a satellite.

A method of wireless communications at a first network entity is described. The method may include transmitting, to a UE, a control message, the control message including an indication of one or more resources to use for a random access preamble associated with a random access procedure and receiving, during the one or more resources and after a duration during which an antenna of the UE is to move from a first direction corresponding to a first beam for communicating with a second network entity to a second direction corresponding to a second beam for communicating with the first network entity, the random access preamble.

An apparatus for wireless communications at a first network entity is described. The apparatus may include a processor, memory coupled with the processor, and instructions stored in the memory. The instructions may be executable by the processor to cause the apparatus to transmit, to a UE, a control message, the control message including an indication of one or more resources to use for a random access preamble associated with a random access procedure and receive, during the one or more resources and after a duration during which an antenna of the UE is to move from a first direction corresponding to a first beam for communicating with a second network entity to a second direction corresponding to a second beam for communicating with the first network entity, the random access preamble.

Another apparatus for wireless communications at a first network entity is described. The apparatus may include means for transmitting, to a UE, a control message, the control message including an indication of one or more resources to use for a random access preamble associated with a random access procedure and receiving, during the one or more resources and after a duration during which an antenna of the UE is to move from a first direction corresponding to a first beam for communicating with a second network entity to a second direction corresponding to a second beam for communicating with the first network entity, the random access preamble.

A non-transitory computer-readable medium storing code for wireless communications at a first network entity is described. The code may include instructions executable by a processor to transmit, to a UE, a control message, the control message including an indication of one or more resources to use for a random access preamble associated with a random access procedure and receive, during the one or more resources and after a duration during which an antenna of the UE is to move from a first direction corresponding to a first beam for communicating with a second network entity to a second direction corresponding to a second beam for communicating with the first network entity, the random access preamble.

Some examples of the method, apparatuses, and non-transitory computer-readable medium described herein may further include operations, features, means, or instructions for transmitting, to the UE, a downlink control channel order, the downlink control channel order including an indication of the duration, where receiving the random access preamble after the duration may be based on transmitting the downlink control channel order.

Some examples of the method, apparatuses, and non-transitory computer-readable medium described herein may further include operations, features, means, or instructions for transmitting a DCI message, a MAC-CE, or both, the DCI message, the MAC-CE, or both including an index corresponding to the random access preamble, an indication of one or more random access occasions, or both.

In some examples of the method, apparatuses, and non-transitory computer-readable medium described herein, receiving the random access preamble may include operations, features, means, or instructions for receiving the random access preamble based on the duration and an additional duration, the additional duration including an uplink channel preparation time, a BWP switching duration, an operational frequency range duration, or any combination thereof.

Some examples of the method, apparatuses, and non-transitory computer-readable medium described herein may further include operations, features, means, or instructions for receiving the random access preamble after a given duration based on a capability of the UE to move the antenna of the UE and transmit the random access preamble concurrently, where the given duration corresponds to the shorter of the duration and the additional duration.

Some examples of the method, apparatuses, and non-transitory computer-readable medium described herein may further include operations, features, means, or instructions for receiving the random access preamble after the duration and the additional duration.

In some examples of the method, apparatuses, and non-transitory computer-readable medium described herein, the first network entity may be a target network entity in a change of association procedure.

In some examples of the method, apparatuses, and non-transitory computer-readable medium described herein, the change of association procedure may be a handover between two cells.

In some examples of the method, apparatuses, and non-transitory computer-readable medium described herein, the change of association procedure may be a beam switching operation within a same cell.

In some examples of the method, apparatuses, and non-transitory computer-readable medium described herein, transmitting the control message may include operations, features, means, or instructions for transmitting, to the UE, an indication of location information of the target network entity, an identifier corresponding to the target network entity, or both.

In some examples of the method, apparatuses, and non-transitory computer-readable medium described herein, the control message may be an RRC message.

In some examples of the method, apparatuses, and non-transitory computer-readable medium described herein, transmitting the control message may include operations, features, means, or instructions for transmitting an indication of the duration, the duration corresponding to a handover outage time, a duration for the UE to apply frequency compensation, a duration for frequency retuning, or any combination thereof.

In some examples of the method, apparatuses, and non-transitory computer-readable medium described herein, the indication may be a field in an RRC message.

In some examples of the method, apparatuses, and non-transitory computer-readable medium described herein, transmitting the control message including the indication of one or more resources may include operations, features, means, or instructions for transmitting an index corresponding to the random access preamble, one or more random access occasions for transmitting the random access preamble, or any combination thereof.

In some examples of the method, apparatuses, and non-transitory computer-readable medium described herein, the UE and the first network entity may be associated with a non-terrestrial network, and where the network entity may be a satellite.

A method of wireless communications at a network entity is described. The method may include transmitting, to a UE, a control message, the control message including an indication of a pattern of DRX cycle for a first beam for communicating with the network entity, each DRX cycle including an active reception duration and an inactive reception duration and communicating with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell.

An apparatus for wireless communications at a network entity is described. The apparatus may include a processor, memory coupled with the processor, and instructions stored in the memory. The instructions may be executable by the processor to cause the apparatus to transmit, to a UE, a control message, the control message including an indication of a pattern of DRX cycle for a first beam for communicating with the network entity, each DRX cycle including an active reception duration and an inactive reception duration and communicate with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell.

Another apparatus for wireless communications at a network entity is described. The apparatus may include means for transmitting, to a UE, a control message, the control message including an indication of a pattern of DRX cycle for a first beam for communicating with the network entity, each DRX cycle including an active reception duration and an inactive reception duration and communicating with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell.

A non-transitory computer-readable medium storing code for wireless communications at a network entity is described. The code may include instructions executable by a processor to transmit, to a UE, a control message, the control message including an indication of a pattern of DRX cycle for a first beam for communicating with the network entity, each DRX cycle including an active reception duration and an inactive reception duration and communicate with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell.

In some examples of the method, apparatuses, and non-transitory computer-readable medium described herein, the control message may include operations, features, means, or instructions for transmitting a beam switching command based on the timer expiring at the UE, where the UE moves the antenna from the first direction to the second direction based on transmitting the beam switching command.

Some examples of the method, apparatuses, and non-transitory computer-readable medium described herein may further include operations, features, means, or instructions for receiving, from the UE, a feedback message corresponding to transmitting the beam switching command.

In some examples of the method, apparatuses, and non-transitory computer-readable medium described herein, the timer corresponds to a handover outage time, a duration for the UE to apply frequency compensation, a duration for frequency retuning, or any combination thereof.

In some examples of the method, apparatuses, and non-transitory computer-readable medium described herein, the control message may include operations, features, means, or instructions for transmitting, to the UE and based on the timer expiring, an indication to perform a change of association procedure based on the first cell being different than the second cell.

In some examples of the method, apparatuses, and non-transitory computer-readable medium described herein, the change of association procedure may be a handover procedure from a current cell associated with the network entity to a target cell associated with a target network entity, where the second beam may be for communicating with the target network entity.

In some examples of the method, apparatuses, and non-transitory computer-readable medium described herein, the timer corresponds to a duration for the UE to enter a coverage area associated with the second beam, a handover outage time, a duration for the UE to apply frequency compensation, a duration for frequency retuning, or any combination thereof.

In some examples of the method, apparatuses, and non-transitory computer-readable medium described herein, the control message includes an indication of the active reception duration, the inactive reception duration, a DRX inactivity timer, a DRX slot offset, a DRX long cycle, a start offset of the DRX long cycle, a DRX short cycle, a DRX short cycle timer, an initial BWP configuration of the second beam, or any combination thereof.

In some examples of the method, apparatuses, and non-transitory computer-readable medium described herein, the UE and the network entity may be associated with a non-terrestrial network, and where the network entity may be a satellite.

A method of wireless communications at a network entity is described. The method may include determining information corresponding to one or more of a set of cells, the set of cells corresponding to one or more candidate network entities, the information associated with a capability of the UE corresponding to moving an antenna during a duration and a state of the UE, transmitting, to the UE, the information for a cell reselection procedure from a current cell associated with the network entity to a target cell associated with a candidate network entity of the one or more candidate network entities, and refraining from communicating with the UE based on the UE performing the cell reselection procedure.

An apparatus for wireless communications at a network entity is described. The apparatus may include a processor, memory coupled with the processor, and instructions stored in the memory. The instructions may be executable by the processor to cause the apparatus to determine information corresponding to one or more of a set of cells, the set of cells corresponding to one or more candidate network entities, the information associated with a capability of the UE corresponding to moving an antenna during a duration and a state of the UE, transmit, to the UE, the information for a cell reselection procedure from a current cell associated with the network entity to a target cell associated with a candidate network entity of the one or more candidate network entities, and refrain from communicating with the UE based on the UE performing the cell reselection procedure.

Another apparatus for wireless communications at a network entity is described. The apparatus may include means for determining information corresponding to one or more of a set of cells, the set of cells corresponding to one or more candidate network entities, the information associated with a capability of the UE corresponding to moving an antenna during a duration and a state of the UE, transmitting, to the UE, the information for a cell reselection procedure from a current cell associated with the network entity to a target cell associated with a candidate network entity of the one or more candidate network entities, and refraining from communicating with the UE based on the UE performing the cell reselection procedure.

A non-transitory computer-readable medium storing code for wireless communications at a network entity is described. The code may include instructions executable by a processor to determine information corresponding to one or more of a set of cells, the set of cells corresponding to one or more candidate network entities, the information associated with a capability of the UE corresponding to moving an antenna during a duration and a state of the UE, transmit, to the UE, the information for a cell reselection procedure from a current cell associated with the network entity to a target cell associated with a candidate network entity of the one or more candidate network entities, and refrain from communicating with the UE based on the UE performing the cell reselection procedure.

Some examples of the method, apparatuses, and non-transitory computer-readable medium described herein may further include operations, features, means, or instructions for determining an indication of a cell identifier for each cell of the set of cells, location information corresponding to the one or more candidate network entities, relative speed information corresponding to the one or more candidate network entities, orbital information corresponding to the one or more candidate network entities, a random access preamble for each cell of the set of cells, a priority associated with the one or more candidate network entities, or any combination thereof.

In some examples of the method, apparatuses, and non-transitory computer-readable medium described herein, transmitting the information for the cell reselection procedure may include operations, features, means, or instructions for receiving, from the UE, an indication of a capability of the UE to perform the cell reselection procedure from the current cell to the target cell.

In some examples of the method, apparatuses, and non-transitory computer-readable medium described herein, the UE and the network entity may be associated with a non-terrestrial network, and where the network entity may be a satellite.

### BRIEF DESCRIPTION OF THE DRAWINGS

FIGS. 1 and 2 illustrates examples of wireless communications systems that support satellite tracking related methods in accordance with aspects of the present disclosure.

FIGS. 3 and 4 illustrates examples of timelines that supports satellite tracking related methods in accordance with aspects of the present disclosure.

FIGS. 5 through 8 illustrate examples of process flows that supports satellite tracking related methods in accordance with aspects of the present disclosure.

FIGS. 9 and 10 show block diagrams of devices that support satellite tracking related methods in accordance with aspects of the present disclosure.

FIG. 11 shows a block diagram of a communications manager that supports satellite tracking related methods in accordance with aspects of the present disclosure.

FIG. 12 shows a diagram of a system including a device that supports satellite tracking related methods in accordance with aspects of the present disclosure.

FIGS. 13 and 14 show block diagrams of devices that support satellite tracking related methods in accordance with aspects of the present disclosure.

FIG. 15 shows a block diagram of a communications manager that supports satellite tracking related methods in accordance with aspects of the present disclosure.

FIG. 16 shows a diagram of a system including a device that supports satellite tracking related methods in accordance with aspects of the present disclosure.

FIGS. 17 through 32 show flowcharts illustrating methods that support satellite tracking related methods in accordance with aspects of the present disclosure.

### DETAILED DESCRIPTION

In some cases, a user equipment (UE) and a network entity, such as a satellite, may transmit control information or data messages using one or more beams associated with one or more bandwidth parts (BWPs). The UE may switch beams for communicating during a beam switching operation. For example, a current beam may move relative to the UE, so the UE may switch to a target beam during a beam switching operation. The angle of the target beam, however, may differ from the angle of the current beam. That is, there may be an abrupt change in pointing angle of an antenna at the UE between a current beam and a target beam. For example, if the UE is performing a change of association procedure between two beams entities, an outgoing network entity may produce the current beam, and an incoming satellite may produce the target beam. The UE may alternatively perform a change of association procedure between two beams upon waking up from a sleep mode. It may take a relatively long time for the UE to move the antenna from the direction of the current beam to the direction of the target beam. The duration the UE is moving the antenna may be referred to as a handover outage time, and may cause signaling latency (e.g., due to delay in communications when performing the beam switching operation), among other disadvantages.

As described herein, a UE may account for the time it takes to move an antenna at the UE from a direction of a current beam to the direction of a target beam (e.g., a beam switching duration) in a beam switching procedure. In some cases, the UE may report a capability to a device, such as a current network entity. For example, the UE may report an antenna pointing capability (which may be measured in milliseconds (ms) per degree in some examples), one or more capability parameters (such as the type of antenna, the number of antennas, the tracking mode, or any combination), or both to the device, such as the current network entity. The UE may perform the beam switching operation to a target beam based on the capability. The target beam may be a beam of the device (e.g., current network entity) if the UE wakes up from a sleep mode and moves the direction of the antenna or a beam of a target device (e.g., target network entity) in a change of association procedure.

Additionally or alternatively, the UE may account for the beam switching duration based on receiving control signaling, such as radio resource control (RRC) signaling, a downlink control channel (e.g., physical downlink control channel (PDCCH)) order, or both. In some cases, the control signaling may include an identity of a target network entity, one or more resources for a random access preamble in a random access procedure, an indication of the beam switching duration, or any combination. In some cases, the UE may derive the beam switching duration after receiving the control signaling based on a handover outage time, the time it takes for the UE to apply frequency compensation, the time it takes for frequency retuning, or any combination. The UE may perform the beam switching operation based on receiving the downlink control channel order (e.g., after receiving a control message via RRC signaling).

In some examples, the UE may account for the beam switching duration based on receiving a discontinuous reception (DRX) cycle configuration from the current network entity or the target network entity. For example, a current network entity may configure the UE with a DRX cycle (e.g., including an on duration and an off duration) and a timer. The UE may activate the timer for a duration and may perform a change of association operation to a target beam of a target network entity based on the timer expiring.

In some cases, the UE may perform a cell reselection procedure based on an antenna pointing capability and a state of the UE or one or more candidate cells. The UE may reselect a cell from multiple candidate cells associated with one or more network entities based on receiving information about the multiple candidate cells from the current network entity, such as a current satellite or a base station in communication with the UE.

Aspects of the disclosure are initially described in the context of wireless communications systems. Aspects of the disclosure are further described in the context of a timelines and process flows. Aspects of the disclosure are further illustrated by and described with reference to apparatus diagrams, system diagrams, and flowcharts that relate to satellite tracking related methods.

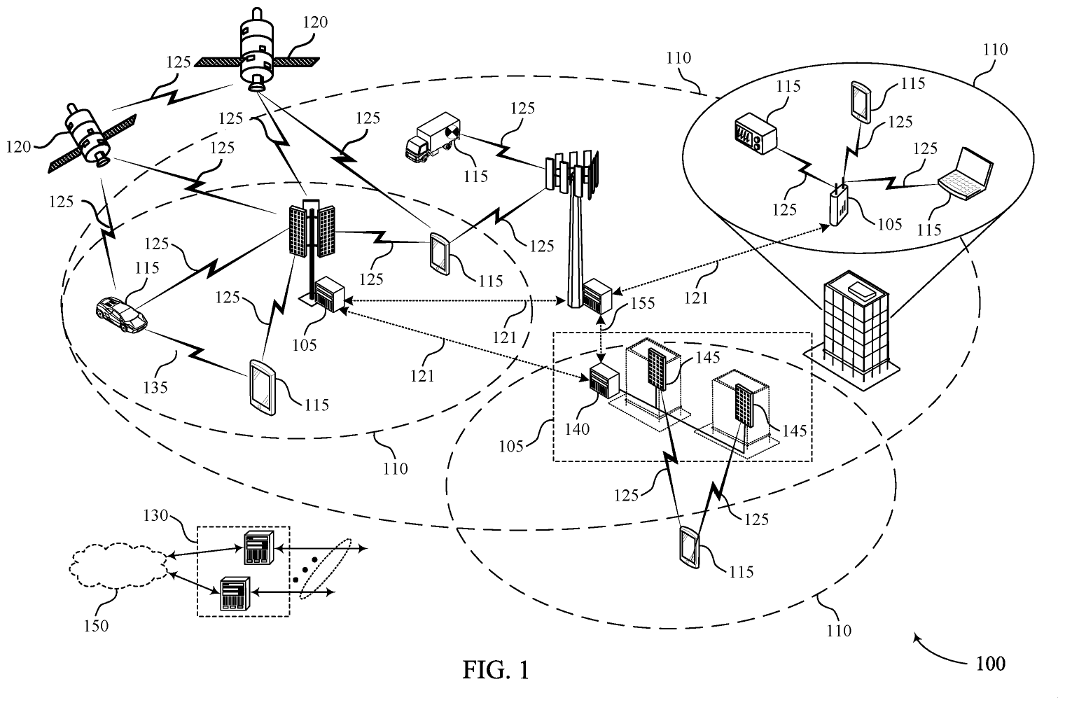

FIG. 1 illustrates an example of a wireless communications system 100 that supports satellite tracking related methods in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 121 (e.g., via an S1, N2, N3, or other interface). The base stations 105 may communicate with one another over the backhaul links 121 (e.g., via an X2, Xn, or other interface) either directly (e.g., directly between base stations 105), or indirectly (e.g., via core network 130), or both. In some examples, the backhaul links 121 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to any combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single bandwidth part (BWP) for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T, =1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or any combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use any combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include any combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Wireless communications system 100 may also include one or more network entities 120, which may in some examples be or include satellites, among other devices. A network entity 120, or satellite, may communicate with base stations 105 (also referred to as gateways in non-terrestrial networks) and UEs 115 (or other high altitude or terrestrial communications devices). The network entity 120 may be any suitable type of communication satellite configured to relay communications between different end nodes in a wireless communications system. The network entity 120 may be an example of a space satellite, a balloon, a dirigible, an airplane, a drone, an unmanned aerial vehicle, or the like. In some examples, the network entity 120 may be in a geosynchronous or geostationary earth orbit, a low earth orbit or a medium earth orbit. A network entity 120 may be a multi-beam satellite configured to provide service for multiple service beam coverage areas in a predefined geographical service area. The network entity 120 may be any distance away from the surface of the earth. A network entity 120 may be a high altitude platform station (HAPS), e.g., a balloon.

In some cases, a cell may be provided or established by a network entity 120 as part of a non-terrestrial network. A network entity 120 may, in some cases, perform the functions of a base station 105, act as a bent-pipe satellite, or may act as a regenerative satellite, or any combination thereof. In other cases, network entity 120 may be an example of a smart satellite, or a satellite with intelligence. For example, a smart satellite may be configured to perform more functions than a regenerative satellite (e.g., may be configured to perform particular algorithms beyond those used in regenerative satellites, to be reprogrammed, etc.). A bent-pipe transponder or satellite may be configured to receive signals from ground stations and transmit those signals to different ground stations. In some cases, a bent-pipe transponder or satellite may amplify signals or shift from uplink frequencies to downlink frequencies. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or any combination thereof. For example, a bent-pipe satellite (e.g., network entity 120) may receive a signal from a base station 105 and may relay the signal to a UE 115 or base station 105, or vice-versa. In accordance with one or more aspects of the present disclosure, a UE 115 may communicate with a cell provided or established by a network entity 120 (e.g., via a base station 105 or a network entity 120 performing the functions of a base station 105) according to an identified default set of one or more beams based on an inactivity timer expiring, which may enhance communications reliability.

In some cases, a UE 115 and a network entity 120 may transmit control information or data messages using one or more beams associated with one or more BWPs. The UE 115 may communicate with the network entity 120 using one or more antennas oriented in the direction of the beam. In some examples, the UE 115 may move the antenna from a current beam to a target beam in a beam switching operation. The difference in angle of the pointing direction of an antenna at the UE 115 from the current beam to the target beam may be referred to as a change in pointing angle. In some cases, such as when the UE 115 is performing a beam switching operation to a beam of a different network entity 120 than the current beam or when the UE 115 wakes up from a sleep, the change in pointing angle may be abrupt. This abrupt change in pointing angle may cause a delay while the UE 115 switches an antenna from the direction of the current beam to the direction of the target beam, which may be referred to as a handover outage time and may cause signaling latency at the UE 115 related to communicating with a network entity 120 using the target beam.

In some cases, a UE 115 may perform a beam switching operation from a current beam to a target beam based on transmitting a capability report including an antenna pointing capability, a list of one or more detailed capabilities, or both to a network entity 120 (e.g., a current network entity 120 or a target network entity 120). In some examples, the UE 115 may perform a random access procedure as part of a change of association operation. The UE 115 may receive a control message from the network entity 120 that includes an identity of a target network entity 120, one or more resources for the random access procedure, or both. In some cases, the control message may include an indication of a beam switching duration, which may be the time it takes for the UE 115 to move an antenna from a current beam to a target beam in the change of association operation. In some other cases, the UE 115 may derive the beam switching duration based on a handover outage time, a time for the UE 115 to apply a frequency compensation, the time for frequency retuning, or any combination. The UE 115 may transmit a random access preamble to a network entity 120 using a target beam based on moving the antenna during the beam switching duration.

In some cases, the network (e.g., using a network entity 120 or a base station 105) may configure the UE 115 with a DRX cycle for communication. In some cases, the configuration may include a timer corresponding to an off duration of the DRX operation. The UE 115 may perform a change of association operation from a current beam to a target beam based on the timer expiring (e.g., during an on duration of the DRX cycle). In some examples, the UE 115 may perform a cell reselection procedure based on an antenna pointing capability and the state of one or more candidate cells. For example, the UE 115 may reselect a cell from multiple candidate cells associated with one or more candidate network entities 120 based on one or more factors related to the candidate network entities 120 and the antenna of the UE 115. In some cases, a base station 105 or a current network entity 120, may transmit information about the incoming candidate network entities 120 to the UE 115. The UE 115 may perform a cell reselection from a current beam associated with a cell from a current network entity 120 to a target beam associated with a candidate cell from a candidate network entity 120.

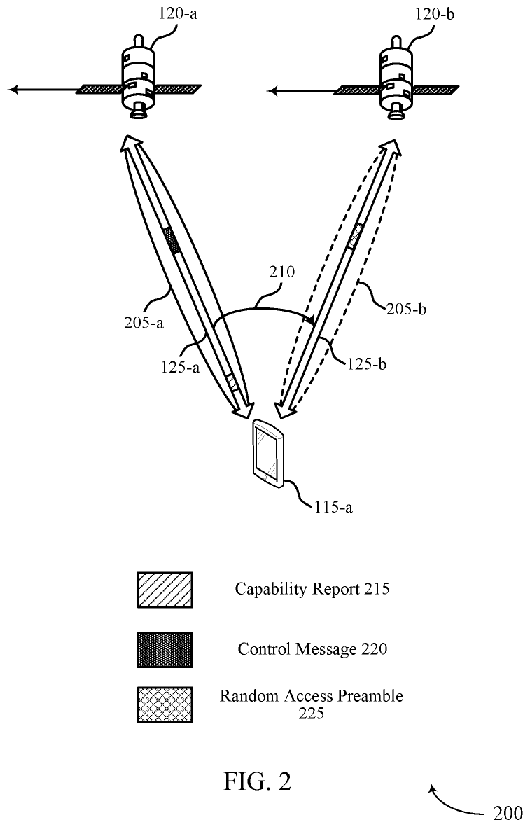

FIG. 2 illustrates an example of a wireless communications system 200 that supports satellite tracking related methods in accordance with aspects of the present disclosure. In some examples, wireless communications system 200 may implement aspects of wireless communications system 100. Wireless communications system 200 may include UE 115-a, network entity 120-a, network entity 120-b, communication link 125-a, and communication link 125-b, which may be examples of a UE 115, network entities 120, and communication links 125 as described with reference to FIG. 1. In some cases, a network entity 120 may receive a signal from a base station 105 and may relay the signal to a UE 115 or may perform the functions of a base station 105 as described with reference to FIG. 1. The network entity 120 may be an example of a satellite in a non-terrestrial network.

In some wireless communication environments, a UE 115 may perform a beam switching operation from a current beam 205 to a target beam 205. In some cases, as illustrated in FIG. 2, a network entity 120 may communicate with a UE 115 via a beam 205, which may be a directional beam. The beam 205 may have a beam footprint (e.g., a coverage area of the beam 205). For example, network entity 120-a may communicate with UE 115-a via beam 205-a and any number of additional beams 205. Additionally or alternatively, network entity 120-b may communicate with UE 115-a via beam 205-b and any number of additional beams 205. UE 115-a may, in some examples, derive a beam footprint shape (e.g., hexagonal, circular, elliptical, or the like) based on the shape and structure of the antenna associated with the beam 205. In some other examples, the UE 115-a may derive a beam size based on one or more power levels associated with the beam 205. In some examples, the frequency of beam switching may depend on the mobility of the UE 115, the mobility of the UE 115 in combination with movement of a base station (e.g., a base station 105 as described with reference to FIG. 1), or both. The network entity 120 may configure each beam 205 from a network entity 120 as a cell with an initial BWP per beam (e.g., an initial uplink BWP, an initial downlink BWP, or an uplink BWP and downlink BWP pair). In some cases, each beam 205 may be associated with one or more BWPs in addition to the initial BWP, which the UE 115 and the network entity 120 may use to communicate.

In some cases, the network entity 120 may configure one or more BWPs for a beam 205 per UE 115. The UE 115 may switch BWPs or beams 205. For example, during a beam switching operation, the UE 115 may switch from a BWP in a beam 205 to a BWP in a different beam 205 (e.g., from a BWP in beam 205-a to a BWP in beam 205-b). For example, if the UE 115 moves from a beam footprint associated with beam 205-a to a beam footprint associated with beam 205-b, the UE may switch from a BWP in beam 205-a to a BWP in beam 205-b. In some other examples, the UE 115 may switch from a BWP in a beam 205 to a different BWP in the same beam 205. For example, if the UE 115 performs a BWP switching operation without leaving the beam footprint associated with beam 205-a, the UE 115 may switch from a BWP associated with beam 205-a to another BWP associated with beam 205-a. In some examples, the network entity 120 may configure the one or more beams 205 as a single cell. In some other examples, the network entity 120 may configure the one or more beams 205 as separate cells or as multiple cells. That is, each cell may include one or more beams 205.

In some examples, the UE 115 may communicate with a network entity 120 using one or more antennas oriented in the direction of a beam 205. In some cases, the UE 115 may have multiple antennas, for example, with one oriented towards a current beam 205 and one moving towards a target beam 205. In some other cases, the UE 115 may communicate using a single antenna. The one or more antennas may be examples of an active electronically scanned array (AESA) antenna, a mechanically motor steered dish antenna, or the like. In some cases, the AESA antenna may change a pointing direction (i.e., angle) in less than 1 microsecond (μs) per degree while the mechanically motor steered dish antenna may take a few seconds to move per degree. In some examples, the UE 115 may move the antenna from a current beam 205 to a target beam 205 in a beam switching operation. The difference in angle of the pointing direction of an antenna at the UE 115 from the current beam 205 to the target beam 205 may be referred to as a change in pointing angle 210. In some cases, such as when the UE 115 is performing a beam switching operation to a beam 205 of a different network entity 120 than the current beam 205 or when the UE 115 wakes up from a sleep, the change in pointing angle 210 may be abrupt. This abrupt change in pointing angle 210 may cause a delay while the UE 115 switches an antenna from the direction of the current beam 205 to the direction of the target beam 205, which may be referred to as a handover outage time and may cause signaling latency at the UE 115 related to communicating with a network entity 120 using the target beam 205.

In some cases, a UE 115 may perform a beam switching operation from a current beam 205 to a target beam 205 based on capability reporting from the UE 115. For example, UE 115-a may communicate with network entity 120-a via communication link 125-a using beam 205-a. UE 115-a may transmit a capability report 215 to network entity 120-a. The capability report 215 may include an antenna pointing capability. For example, UE 115-a may include an indicator in capability report 215 that indicates the time it takes for UE 115-a to steer the antenna by an angle (e.g., 0 for less than one ms/degree, 1 for a delay larger than 1 ms/degree, 2 for a delay larger than 100 ms/degree but less than 1 s/degree, 3 for a delay larger than 1 s/degree, or the like). Additionally or alternatively, UE 115-a may include a list of one or more detailed capabilities in the capability report 215. For example, UE 115-a may include the type of antenna (e.g., AESA, motor driven mechanically steered antenna, or the like), the number of antennas (e.g., one or two), the granularity in tracking (e.g., a continuous tracking mode or a step-wise tracking mode), or any combination. If the tracking mode is a step-wise tracking mode, UE 115-a may include the step size (e.g., 1 degree per step, 0.5 degree per step, how much time it takes to finish each step, or the like) in the capability report 215. UE 115-a may perform a beam switching operation based on the capability report 215. For example, UE 115-a may switch from beam 205-a to beam 205-b to communicate with network entity 120-b, which may be an incoming satellite.

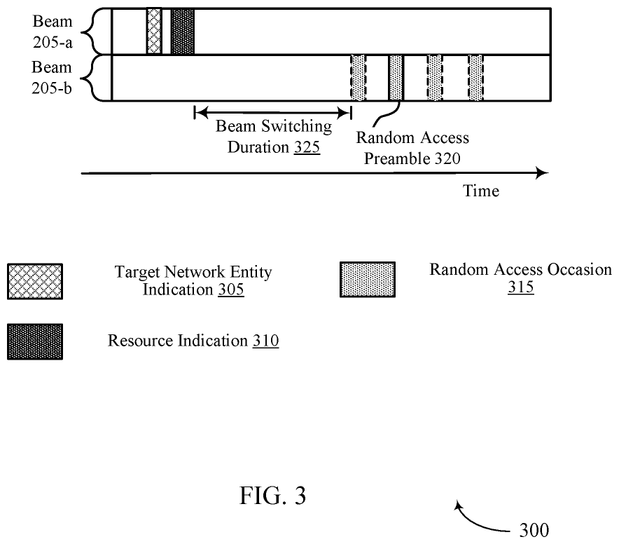

In some cases, the UE 115 may perform a random access procedure as part of a change of association operation. The UE 115 may receive a control message 220 from the network entity 120 that includes an identity of a target network entity 120, one or more resources for the random access procedure, or both. In some cases, the control message 220 may include an indication of a beam switching duration, which may be the time it takes for the UE 115 to move an antenna from a current beam 205 to a target beam 205 in the change of association operation. The change of association operation is a cell handover if the current beam and the target beam belong to two different cells. The change of association operation is a beam switching (e.g., at Layer 1 or Layer 2) if the current beam and the target beam belong to a same cell. In some other cases, the UE 115 may derive the beam switching duration based on a handover outage time, a time for the UE 115 to apply a frequency compensation, the time for frequency retuning, or any combination. For example, UE 115-a may perform a beam switching operation from beam 205-a of network entity 120-a to beam 205-b of network entity 120-b. Network entity 120-a may transmit control message 220 to UE 115-a, the control message 220 indicating the identity of network entity 120-b, one or more resources for the random access procedure, a beam switching duration, or any combination. UE 115-a may move the antenna a change in pointing angle 210 from the direction of beam 205-a to the direction of beam 205-b to communicate with network entity 120-b, which is described in further detail with respect to FIG. 3. UE 115-a may transmit a random access preamble 225 via communication link 125-b to network entity 120-b using beam 205-b based on moving the antenna.

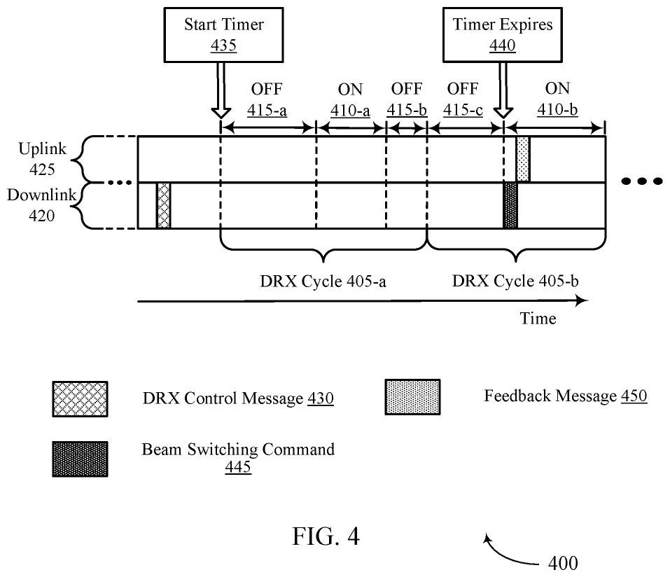

In some cases, the network (e.g., using a network entity 120 or a base station 105) may configure the UE 115 with a DRX cycle for communication. For example, network entity 120-a may transmit a control message 220 including an indication of a DRX on duration, a DRX inactivity timer, a DRX slot offset, a DRX long cycle, a start offset of the DRX long cycle, a DRX short cycle, a DRX short cycle timer, a beam switching duration timer, or any combination. In some cases, UE 115-a may activate the beam switching duration timer based on entering an off duration of the DRX cycle. UE 115-a may perform a change of association operation from beam 205-a to beam 205-b based on the timer expiring (e.g., during an on duration of the DRX cycle), which is described in further detail with respect to FIG. 4.

In some examples, the UE 115 may perform a cell reselection procedure based on an antenna pointing capability and the state of the UE 115 and one or more candidate cells. For example, UE 115-a may reselect a cell from multiple candidate cells associated with one or more candidate network entities 120 based on the location of each candidate network entity 120 (e.g., altitude, orbit, speed, or the like), the change in pointing angle 210 (i.e., the difference between two elevation angles of beams 205 associated with each candidate cell and the current cell), the speed at which UE 115-a steers the antenna (e.g., measured in s/degree), the priority of the candidate network entity 120 (e.g., specified by the network), a delay to meet the quality of service (QoS) requirement or service continuity requirement, the measurement on the link quality of the candidate network entities 120, or any combination. In some cases, a base station 105 or a current network entity 120, such as network entity 120-a, may transmit information about the incoming candidate network entities 120 (e.g., network entity 120-b). For example, network entity 120-a may transmit the cell identifier of each cell associated with the candidate network entities 120, the location or orbital information of the candidate network entities 120, a dedicated random access preamble for each cell associated with each of the candidate network entities 120, the priority among the candidate network entities 120, or any combination to UE 115-a in a control message 220. UE 115-a may perform a cell reselection from beam 205-a associated with a cell from network entity 120-a to beam 205-b associated with a candidate cell from a candidate network entity 120-b.

FIG. 3 illustrates an example of a timeline 300 that supports satellite tracking related methods in accordance with aspects of the present disclosure. In some examples, timeline 300 may implement aspects of wireless communications system 100 wireless, communications system 200, or both. Aspects of timeline 300 may be implemented by a UE 115, a network entity 120, or both, as described with reference to FIGS. 1 and 2. For example, timeline 300 may illustrate a process for a UE 115 to performing a change of association procedure between beams 205 used for communicating with a network entity 120 that accounts for the time it takes to move an antenna to change a pointing angle based on a control message.

In some cases, the network may transmit a control message to the UE 115 from a network entity 120 currently serving the UE 115 using beam 205-a. The control message may include a target network entity indication 305, a resource indication 310, or any combination. For example, the target network entity indication 305 may include an identity of a target network entity 120 in a change of association procedure, such as a handover procedure. In a handover procedure, the UE 115 may switch from a beam 205 associated with the current network entity 120, such as beam 205-a, to a beam 205 associated with a target network entity 120, such as beam 205-b, as described with reference to FIG. 2. In some cases, the current network entity 120 or the UE 115 may determine the target network entity 120 based on the UE location and the ephemeris information of the target network entity. The resource indication 310 may include a random access preamble index, a time-frequency indication of one or more random access occasions 315, or both. For example, the random access preamble index may indicate a random access preamble 320 for the UE 115 to use in a contention-free random access (CFRA) procedure with the target network entity 120. The UE 115 may use the one or more random access occasions 315 to transmit the random access preamble 320 to the target network entity 120 in the random access procedure.

In some cases, the control message may include an indication of the time it takes for the UE 115 to move an antenna a change in pointing angle, such as a beam switching duration 325. The UE 115 may wait for the beam switching duration 325 after receiving the last information in the control message (e.g., the target network entity indication 305, the resource indication 310, or both) before initiating the random access procedure and transmitting the random access preamble 320 to the target network entity 120. In some cases, the beam switching duration 325 may be based on a handover outage time, a time it takes for the UE 115 to apply frequency compensation, a time it takes for frequency retuning, or any combination. The current network entity 120 may transmit the control message via RRC signaling. In some cases, the beam switching duration 325 may be a field in the RRCConfiguration if the UE 115 is not performing a conditional handover procedure. Additionally or alternatively, the beam switching duration 325 may be reflected in a timer-based execution condition if the UE 115 is performing a conditional handover procedure. That is, the UE 115 may start a timer after receiving the control message, the timer duration the same as the beam switching duration 325, which may be indicated in the control message.

In some other cases, the UE 115 may derive the beam switching duration 325, which may be the amount of time the UE 115 waits after receiving the control message before initiating the random access procedure with the target network entity 120. The UE 15 may determine the beam switching duration 325 based on the handover outage time, the time it takes for the UE 115 to apply frequency compensation, the time it takes for frequency retuning, or any combination. In some examples, the UE 115 may calculate the handover outage time based on the ephemeris information for the current network entity 120 and an incoming network entity 120, which may the target network entity 120, the antenna pointing capability of the UE 115 (e.g., antenna type, pointing in s/degree, etc.), or both. In some cases, the network entity 120 may assign the random access preamble 225 to other UEs 115 while the UE 115 is waiting the beam switching duration 325.

In some examples, the network entity 120 may transmit the control message via downlink control channel signaling. The network entity 120 may activate the configuration in the control message by transmitting a second control message. For example, the network entity may transmit a downlink control channel order (e.g., a PDCCH order) to delay a random access procedure with a target network entity 120. The downlink control channel order may trigger the random access preamble 225 when downlink data arrives to a UE 115 that may no longer by synchronized in an RRC connected mode. The current network entity 120 may transmit the control message (e.g., via RRC or a medium access control-control element (MAC-CE)) prior to the downlink control channel order. The current network entity 120 may transmit the downlink control channel order in a downlink control information (DCI) message, a MAC-CE, or the like. The downlink control channel order may include a random access preamble index, a beam index, a random access occasion indication, or any combination corresponding to the target network entity 120.

In some cases, the UE 115 may wait the beam switching duration 325 and an additional duration before initiating the random access procedure with the target network entity 120. The additional duration may include a physical uplink shared channel (PUSCH) preparation time, a BWP switching delay, a frequency range dependent delay (e.g., 0.5 ms for Frequency Range 1 (FR1) and 0.25 ms for Frequency Range 2 (FR2)), a sum of all three, or any combination. In some examples, the UE 115 may derive the random access occasions 315 based on one or more random access preambles 320 allocated to beams if the allocation is signaled in the control message before the downlink control channel order or if the UE 115 extracts the random access occasions 315 from the resource indication 310. The UE 115 may transmit the indicated random access preamble 320 over the one or more derived, or indicated, random access occasions.

FIG. 4 illustrates an example of a timeline 400 that supports satellite tracking related methods in accordance with aspects of the present disclosure. In some examples, timeline 400 may implement aspects of wireless communications system 100, wireless communications system 200, or both. Aspects of timeline 300 may be implemented by a UE 115, a network entity 120, or both, as described with reference to FIGS. 1 and 2. For example, timeline 300 may illustrate a process for a UE 115 to performing a change of association procedure between beams 205 used for communicating with a network entity 120 that accounts for a beam switching duration (e.g., the time it takes to move an antenna to change a pointing angle) based on a DRX cycle configuration.

In some examples, the UE 115 may operate according to one or more DRX cycles 405 (e.g., DRX cycle 405-a and DRX cycle 405-b) to save power at the UE 115. For example, the network, such as a network entity 120 or a base station 105, may configure the UE 115 (e.g., via RRC signaling) with an on duration 410 for monitoring for data traffic and an off duration 415 in which the UE 115 is in a sleep or idle mode. In some examples, such as DRX cycle 405-a, the UE 115 may be in a sleep or idle mode during an off duration 415-a and off duration 415-b. The UE 115 may wake up to receive signaling during on duration 410-a of DRX cycle 405-a. When the network configures the UE 115 with a DRX cycle, the UE 115 may monitor a downlink channel 420 (e.g., a physical downlink control channel (PDCCH)) discontinuously using one or more parameters specified by the DRX cycle configuration. For example, the UE 115 may monitor the downlink channel 420 during an active time based on an on duration timer, a pending scheduling request transmitted on an uplink channel 425 (e.g., a physical uplink control channel (PUCCH)), an uplink grant for a pending retransmission (e.g., a HARQ), a downlink control channel indicating a new transmission has not been received, or any combination.

In some cases, the network may configure one or more DRX cycles 405 with a DRX control message 430. For example, the DRX control message 430 may include one or more parameters for communications with a current network entity 120, such as a DRX on duration 410, a DRX inactivity timer, a DRX slot offset, a DRX long cycle, a start offset of the DRX long cycle, a DRX short cycle, a DRX short cycle timer, or any combination for the one or more DRX cycles 405 (e.g., DRX cycle 405-a, DRX cycle 405-b, or any additional DRX cycles 405). Additionally or alternatively, the DRX control message 430 may include a BWP configuration for a target beam in a change of association procedure from the current beam and an indication of a timer. In some examples, the value of the timer may account for the duration for the UE 115 to enter the coverage area of the target beam, the duration for the UE to change the antenna pointing direction from the current beam to the target beam, the time for frequency retuning, the time for preparing for frequency compensation at the UE 115, or any combination.

In some cases, the UE 115 may start the timer at 435. In some examples, the timer may expire at 440 during an off duration 415-c of DRX cycle 405-b. The UE 115 may cancel the remainder of an interrupted off duration 415-c of DRX cycle 405-b and may stay awake during on duration 410-b until a new DRX configuration is received. In some examples, the on durations 410 of a DRX cycle 405 (e.g., on duration 410-a, on duration 410-b, or both) after the start of the timer 435 may be cancelled. That is, the UE 115 may not wake up during the one duration 410 for one or more DRX cycles 405 after the timer is started at 435. When the timer expires, at 440, the UE 115 may wake up to perform a change of association procedure from a current beam to a target beam. In some examples, the change of association procedure may involve a handover procedure from a current cell of a current network entity 120 to a target cell of a target network entity 120. In some other examples, the change of association procedure may involve changing from a current beam of the current network entity 120 to a target beam of the current network entity 120. The target beam may be from the same cell as the current beam (e.g., the beams from a network entity 120 are configured as a same cell) or from a different cell as the current beam (e.g., each beam is configured as a cell).

If the target beam is in the same cell as the current beam and the UE 115 wakes up to the current beam after the timer expires at 440, the UE 115 may receive a beam switching command 445 on the downlink channel 420. The UE 115 may transmit a feedback message 450, such as an ACK, using the current beam to the current network entity 120 on the uplink channel 425, then may perform a beam switching operation, or a BWP switching operation (e.g., if the target beam is associated with a BWP), to the target beam. If the target beam is in the same cell as the current beam and the UE 115 wakes up to the target beam after the timer expires at 440, the UE 115 may inform the network entity 120 that it has switched to the target beam by sending a random access preamble or another message, such as a scheduling request to the network entity 120. If the target beam is in a different cell and the UE 115 wakes up to the current beam, the UE 115 may receive an indication to perform a handover procedure. The UE 115 may perform the handover procedure based on the indication.

In some examples, the network entity 120 may transmit the DRX control message 430 to the UE 115, and the UE 115 may interrupt DRX cycle 405-b autonomously. For example, the DRX control message 430 may include the one or more DRX parameters, an indication of initial BWPs, or both. The UE 115 may determine a duration for the UE 115 to enter the coverage area of a target beam and may start a timer at 435 to wake itself up based on the duration. The UE 115 may wake up when the timer expires at 440 to prepare for a change of association procedure to the target beam. In some examples, the value of the timer may account for the duration for the UE 115 to enter the coverage area of the target beam, the duration for the UE to change the antenna pointing direction from a current beam to the target beam, the time for frequency retuning, the time for preparing for frequency compensation at the UE 115, or any combination.

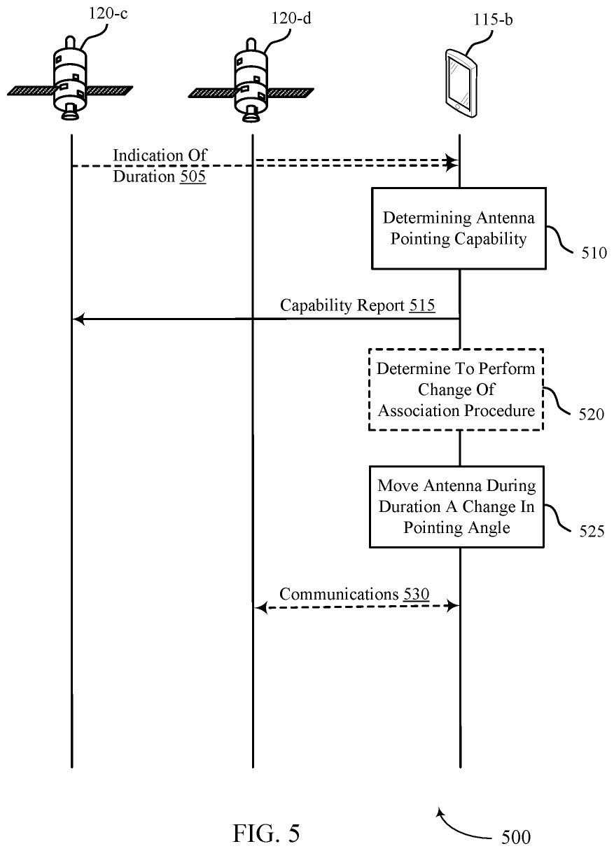

FIG. 5 illustrates an example of a process flow 500 that supports satellite tracking related methods in accordance with aspects of the present disclosure. In some examples, process flow 500 may implement aspects of wireless communications system 100, wireless communications system 200, or both as well as timeline 300 and timeline 400. The process flow 500 may illustrate an example of a UE 115, such as UE 115-b, performing a change of association procedure between beams used for communicating with one or more network entities 120, such as network entity 120-c, network entity 120-d, or both, that accounts for a beam switching duration (e.g., the time it takes to move an antenna to change a pointing angle) based on a capability report from the UE 115. Alternative examples of the following may be implemented, where some processes are performed in a different order than described or are not performed. In some cases, processes may include additional features not mentioned below, or further processes may be added.

At 505, UE 115-b may receive an indication of a duration to steer an antenna based on a difference (e.g., a difference in one or more degrees) between an angle of a pointing direction towards a current beam and an angle of a pointing direction towards a target beam, which may be referred to as a change in pointing angle. In some cases, UE 115-b may receive the indication form network entity 120-c, network entity 120-d, or a base station 105. in some cases, the antenna may be an AESA antenna, a mechanical motor steered antenna, or the like.

At 510, UE 115-b may determine a capability of the UE 115-b to move an antenna during the duration from a direction of a current beam to a direction of a target beam. In some cases, the UE 115-b may communicate with network entity 120-c using a current beam and may communicate with network entity 120-d using a target beam. In some other cases, the UE 115-b may communicate with network entity 120-c using the current beam and the target beam. In some examples, UE 115-b may determine the capability based on an antenna type, a number of antennas at UE 115-b, a continuous tracking mode of the antenna, a step-wise tracking mode of the antenna, or any combination.

At 515, UE 115-b may transmit a capability report including an indication of the determined antenna pointing capability to network entity 120-c. At 520, UE 115-b may determine to perform a change of association procedure between beams. For example, UE 115-b may change from a current beam of network entity 120-c to a target beam of network entity 120-d. In some cases, the change of association procedure may be a handover between two cells. At 525, UE 115-b may move the antenna the change in pointing angle during the duration based on transmitting the capability report at 510.

At 530, UE 115-b may communicate with network entity 120-d. For example, if the target beam in a change of association procedure is from network entity 120-d, then UE 115-b may communicate with network entity 120-d using the target beam. In some other examples, if the target beam in the change of association procedure is from a current network entity, such as network entity 120-c, then UE 115-b may continue to communicate with network entity 120-c using the target beam. In some cases, UE 115-b, network entity 120-c, and network entity 120-d, are in a non-terrestrial network. Network entity 120-c and network entity 120-d may be examples of satellites.

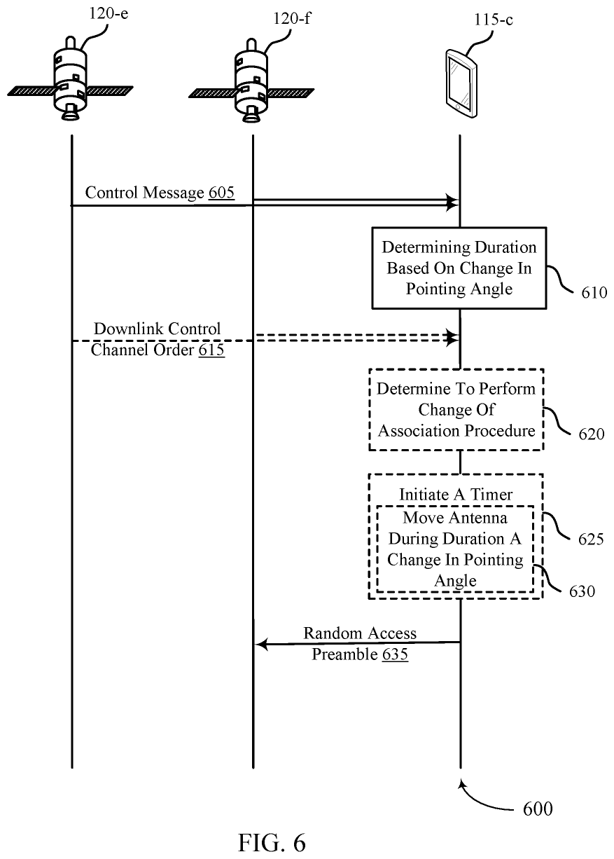

FIG. 6 illustrates an example of a process flow 600 that supports satellite tracking related methods in accordance with aspects of the present disclosure. In some examples, process flow 600 may implement aspects of wireless communications system 100, wireless communications system 200, or both as well as timeline 300 and timeline 400. The process flow 600 may illustrate an example of a UE 115, such as UE 115-c, performing a change of association procedure between beams used for communicating with one or more network entities 120, such as network entity 120-e, network entity 120-f, or both, that accounts for a beam switching duration (e.g., the time it takes to move an antenna to change a pointing angle) based on a control message from a network entity 120. Alternative examples of the following may be implemented, where some processes are performed in a different order than described or are not performed. In some cases, processes may include additional features not mentioned below, or further processes may be added.

At 605, UE 115-c may receive a control message from a network entity 120. In some cases, UE 115-c may receive the control message from a network entity 120-e for a current beam. In some other causes, UE 115-c may receive the control message from a target network entity 120-f for a target beam in a change of association procedure. In some cases, UE 115-c may receive the control message via RRC signaling, a MAC-CE, or the like. The control message may include an indication of one or more resources for UE 115-c to use for a random access preamble in a random access procedure. In some examples, the control message may include an indication of the target network entity 120-f, such as location information of the target network entity 120-f, an identifier of the target network entity 120-f, or both. In some cases, the indication of one or more resources may include an index of the random access preamble, one or more random access occasions for transmitting the random access preamble, or both.

At 610, UE 115-c may determine a duration during which an antenna of UE 115-c is to move from a direction corresponding to a current beam for communicating with network entity 120-e to a direction corresponding to a target beam for communicating with network entity 120-e or network entity 120-f. In some cases, the control message may include an indication of the duration. The duration may be based on a handover outage time, a duration for UE 115-c to apply frequency compensation, a duration for frequency retuning, or any combination. The indication of the duration may be a field in an RRC control message. In some other cases, UE 115-c may derive the duration based on the handover outage time, the duration for UE 115-c to apply frequency compensation, the duration for frequency retuning, or any combination. For example, UE 115-c may determine the handover outage time based on ephemeris information of network entity 120-e, network entity 120-f, or both, an antenna pointing capability of UE 115-c, or both.

At 615, UE 115-c may receive a downlink control channel order (e.g., a PDCCH order). In some cases, UE 115-c may receive the downlink control channel order from a current network entity 120, such as network entity 120-e, a target network entity 120, such as network entity 120-f, or both. The downlink control channel order may include an indication of the duration. The UE 115-c may receive the downlink control channel order via a DCI message, a MAC-CE, or the like after receiving the control message. The downlink control channel order may include an index of the random access preamble, an indication of one or more random access occasions, or both.

At 620, UE 115-c may determine to perform a change of association procedure between beams. For example, UE 115-c may change from a current beam of network entity 120-e to a target beam of network entity 120-f. In some cases, the change of association procedure may be a handover between two cells.

At 625, UE 115-c may initiate a timer based on receiving an indication of the duration in the control message. The timer duration may be the same as the indicated duration. In some cases, at 630, UE 115-c may move the antenna during the duration the change in pointing angle from the current beam direction to the target beam direction (e.g., while the timer is activated).

At 635, UE 115-c may transmit the random access preamble using the one or more resources and after the duration. In some cases, UE 115-c may transmit the random access preamble to the target network entity 120-f as part of the handover procedure. UE 115-c and network entity 120-f may communicate using the target beam in the change of association procedure, such as the handover procedure. In some cases, UE 115-c may transmit the random access preamble based on receiving the downlink control channel order at 615. In some examples, UE 115-c may determine an additional duration including an uplink channel preparation time, a BWP switching duration, an operational frequency range duration, or any combination. UE 115-c may transmit the random access preamble based on the duration and the additional duration. For example, UE 115-c may determine a given duration based on a capability of the UE 115-c to move the antenna of the UE 115-c and transmit the random access preamble concurrently. UE 115-c may transmit the random access preamble after the give duration, where the given duration is the shorter of the duration and the additional duration. In some other examples, UE 115-c may transmit the random access preamble after the duration and the additional duration. In some cases, UE 115-c may transmit the random access preamble after the timer expires. In some cases, UE 115-c, network entity 120-e, and network entity 120-f, are in a non-terrestrial network. Network entity 120-e and network entity 120-f may be examples of satellites.

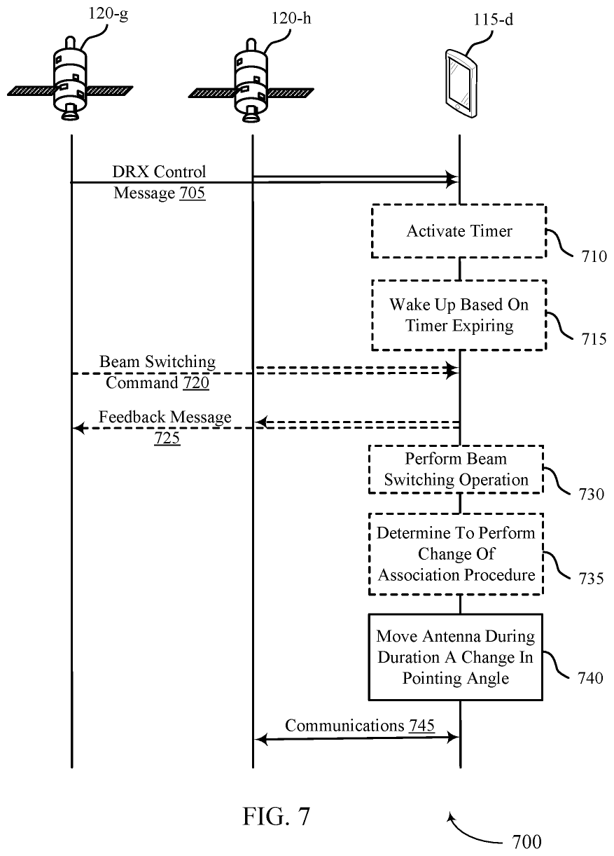

FIG. 7 illustrates an example of a process flow 700 that supports satellite tracking related methods in accordance with aspects of the present disclosure. In some examples, process flow 700 may implement aspects of wireless communications system 100, wireless communications system 200, or both as well as timeline 300 and timeline 400. The process flow 700 may illustrate an example of a UE 115, such as UE 115-d, performing a change of association procedure between beams used for communicating with one or more network entities 120, such as network entity 120-g, network entity 120-h, or both, that accounts for a beam switching duration (e.g., the time it takes to move an antenna to change a pointing angle) based on a DRX cycle configuration. Alternative examples of the following may be implemented, where some processes are performed in a different order than described or are not performed. In some cases, processes may include additional features not mentioned below, or further processes may be added.

At 705, UE 115-d may receive a DRX control message indicating a pattern of DRX cycles for a current beam for communicating with network entity 120-g or a target beam for communicating with network entity 120-h. UE 115-d may receive the control message from network entity 120-g, network entity 120-h, or both. In some cases, UE 115-d may receive the DRX control message via RRC signaling, a MAC-CE, or the like. Each DRX cycle may include an active duration, or an on duration, and an inactive duration, or an off duration. In some cases, the DRX control message may include an indication of a timer. The timer may include a duration for UE 115-d to enter a coverage area of a target beam, a handover outage time, a duration for UE 115-d to apply frequency compensation, a duration for frequency retuning, or any combination. The control message may include an indication of the on reception duration, the off reception duration, a DRX inactivity timer, a DRX slot offset, a DRX long cycle, a start offset of the DRX long cycle, a DRX short cycle, a DRX short cycle timer, an initial BWP configuration of the target beam, or any combination.

At 710, UE 115-d may activate the timer after receiving the indication of the timer in the DRX control message. At 715, UE 115-d may wake up based on the timer expiring.

At 720, UE 115-d may receive a beam switching command from network entity 120-g, network entity 120-h, or both. The beam switching command may include an indication of the target beam to switch to from the current beam.

At 725, UE 115-d may transmit a feedback message to network entity 120-g, network entity 120-h, or both based on receiving the beam switching command. For example, UE 115-d may transmit an acknowledgement (ACK) if UE 115-d successfully receives the beam switching command or a negative acknowledgement (NACK) if UE 115-d does not receive the beam switching command successfully. At 730, UE 115-d may perform a beam switching operation from a BWP of a current beam to a BWP of a target beam based on receiving the beam switching command at 720.

At 735, UE 115-d may determine to perform a change of association procedure between beams based on the current cell being different than the target cell when the timer expires. For example, UE 115-d may change from a current beam of network entity 120-g to a target beam of network entity 120-h. In some cases, the change of association procedure may be a handover between two cells. UE 115-d may transmit an indication of the change of association procedure to a target network entity 120 of the target beam, such as network entity 120-h. The indication may include a random access preamble, a scheduling request, or the like.

At 740, UE 115-d may move the antenna of UE 115-d the change in pointing angle during the duration. The current beam may be used for communicating with a current cell and the target beam may be used for communicating with a target cell. The current cell may be from network entity 120-g, while the target cell may be from network entity 120-g or network entity 120-h. UE 115-d may move the antenna based on receiving the beam switching command at 720.

At 745, UE 115-d may communicate with the network entity 120 of the target cell (e.g., network entity 120-h) during an on duration of at least one of the DRX cycles based on moving the antenna. In some cases, UE 115-d, network entity 120-g, and network entity 120-h, are in a non-terrestrial network. Network entity 120-g and network entity 120-h may be examples of satellites.

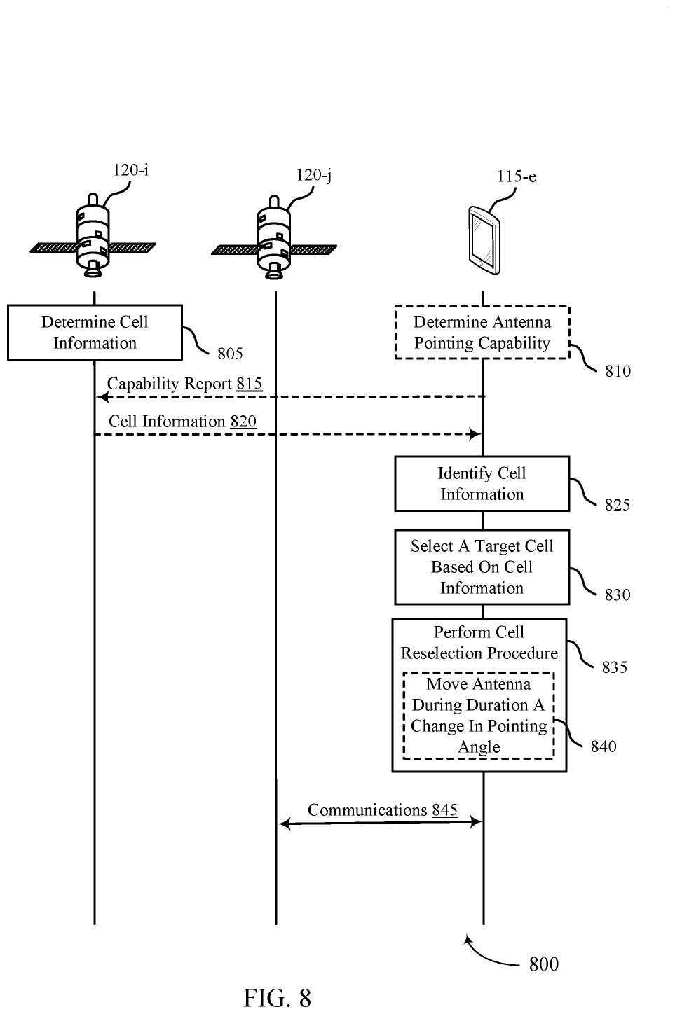

FIG. 8 illustrates an example of a process flow 800 that supports satellite tracking related methods in accordance with aspects of the present disclosure. In some examples, process flow 800 may implement aspects of wireless communications systems 100, wireless communications system 200, or both as well as timeline 300 and timeline 400. The process flow 800 may illustrate an example of a UE 115, such as UE 115-e, performing a change of association procedure between beams used for communicating with one or more network entities 120, such as network entity 120-i, network entity 120-j, or both, that accounts for a beam switching duration (e.g., the time it takes to move an antenna to change a pointing angle) based on a cell reselection procedure. Alternative examples of the following may be implemented, where some processes are performed in a different order than described or are not performed. In some cases, processes may include additional features not mentioned below, or further processes may be added.

At 805, network entity 120-i may determine information for multiple cells of one or more candidate network entities 120 in a cell reselection procedure. The information may be based on the capability of UE 115-e to move an antenna during a duration and a state of UE 115-e or the one or more candidate cells. In some cases, network entity 120-i may determine an indication of a cell identifier for each cell of the multiple cells, location information, relative speed information, or both of the one or more candidate network entities 120, a random access preamble for each cell of the multiple cells, a priority associated with the one or more candidate network entities 120, or any combination. The information may include location information associated with each candidate network entity 120 of the one or more candidate network entities 120, the orbital information associated with each candidate network entity 120 of the one or more candidate network entities 120, a difference measured in angles corresponding to moving the antenna from a direction associated with the current cell to a direction associated with the target cell, a speed corresponding to moving the antenna, an indication of a cell identifier for each cell of the multiple cells, a priority associated with the one or more candidate network entities, a duration corresponding to a QoS requirement at UE 115-e, one or more measurements corresponding to a link quality between UE 115-e and the one or more candidate network entities 120, or any combination.

At 810, UE 115-e may determine a capability of UE 115-e to perform the cell reselection procedure from a current cell to a target cell. At 815, UE 115-e may transmit a capability report to network entity 120-i. The capability report may include an indication of a capability of UE 115-e to perform the cell reselection procedure from the current cell to the target cell. At 820, network entity 120-i may transmit the cell information to UE 115-e for the cell reselection procedure from the current cell of network entity 120-i to the target cell of a candidate network entity 120, such as network entity 120-j. Network entity 120-i may transmit the cell information based on receiving the capability report from UE 115-e.

At 825, UE 115-e may identify the information network entity 120-i determined at 805. For example, UE 115-e may receive the cell information from network entity 120-i or may independently determine the cell information.

At 830, UE 115-e may select the target cell of the candidate network entity 120-j for a cell reselection procedure from a current cell based on the information. At 835, UE 115-e may perform the cell reselection procedure to the target cell based on selecting the target cell at 830. At 840, UE 115-e may move the antenna of UE 115-e a change in pointing angle from a beam of the current cell to a beam of the target cell during a duration of the cell reselection procedure.

At 845, UE 115-e may communicate with network entity 120-j. For example, if the target beam in a cell reselection procedure is from network entity 120-j, then UE 115-e may communicate with network entity 120-j using the target beam. Network entity 120-i may refrain from communicating with UE 115-e based on UE 115-e performing the cell reselection procedure. In some cases, UE 115-e, network entity 120-i, and network entity 120-j, are in a non-terrestrial network. Network entity 120-i and network entity 120-j may be examples of satellites.

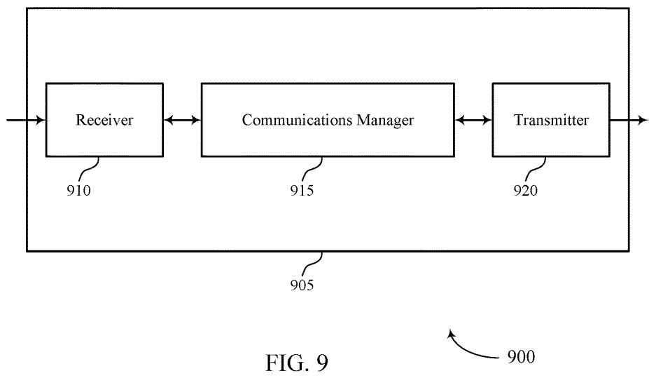

FIG. 9 shows a block diagram 900 of a device 905 that supports satellite tracking related methods in accordance with aspects of the present disclosure. The device 905 may be an example of aspects of a UE 115 as described herein. The device 905 may include a receiver 910, a communications manager 915, and a transmitter 920. The device 905 may also include a processor. Each of these components may be in communication with one another (e.g., via one or more buses).

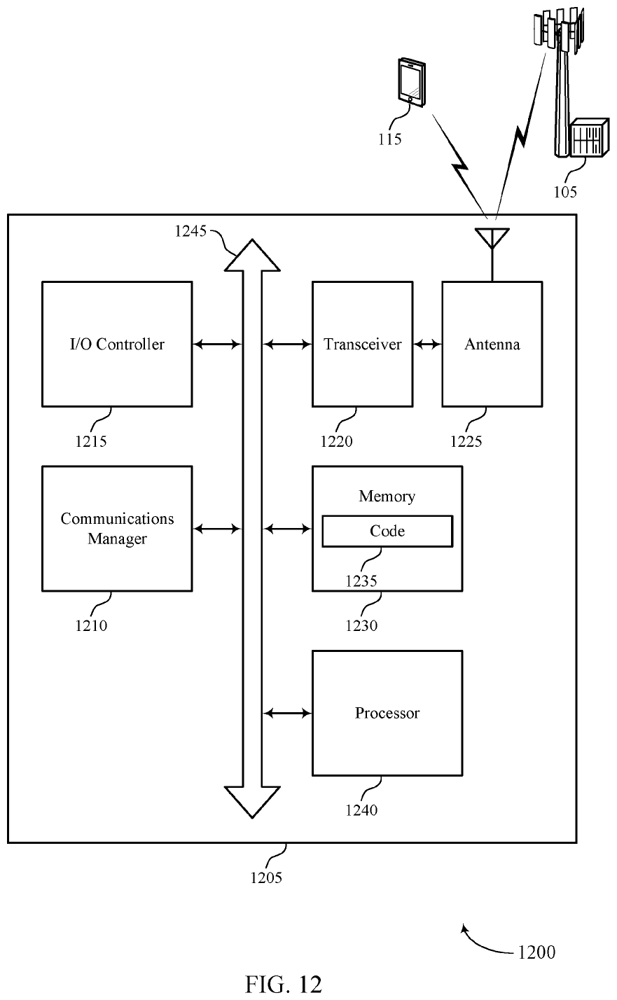

The receiver 910 may receive information such as packets, user data, or control information associated with various information channels (e.g., control channels, data channels, and information related to satellite tracking related methods, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may determine a capability of the UE associated with moving an antenna during a duration from a first direction corresponding to a first beam for communicating with a network entity to a second direction corresponding to a second beam for communicating, transmit, to the network entity, an indication of the capability associated with moving the antenna during the duration from the first direction to the second direction, and move the antenna, during the duration, from the first direction to the second direction based on transmitting the indication of the capability.

The communications manager 915 may also receive, from a network entity, a control message, the control message including an indication of one or more resources to use for a random access preamble associated with a random access procedure, determine, based on receiving the control message, a duration during which an antenna of the UE is to move from a first direction corresponding to a first beam for communicating with the network entity to a second direction corresponding to a second beam for communicating, and transmit, after the duration, the random access preamble using the one or more resources.

The communications manager 915 may also receive, from a network entity, a control message, the control message including an indication of a pattern of DRX cycles for a first beam for communicating with the network entity, each DRX cycle including an active reception duration and an inactive reception duration, move an antenna of the UE from a first direction corresponding to the first beam to a second direction corresponding to a second beam for communicating, where the first beam is associated with a first cell and the second beam is associated with a second cell, and communicate with the network entity during an active reception duration of at least one DRX cycle based on moving the antenna from the first direction to the second direction.

The communications manager 915 may also identify information corresponding to one or more of a set of cells, the set of cells corresponding to one or more candidate network entities, the information associated with a capability of the UE corresponding to moving an antenna during a duration and a state of the UE, select, for a cell reselection procedure from a current cell and based on the information, a target cell from the set of cells, the target cell associated with a candidate network entity of the one or more candidate network entities, perform the cell reselection procedure to the target cell based on selecting the target cell from the set of cells, and communicate with the candidate network entity based on the cell reselection procedure. The communications manager 915 may be an example of aspects of the communications manager 1210 described herein.

The actions performed by the communications manager 915 as described herein may be implemented to realize one or more potential advantages. One implementation may enable a UE to perform a change of association procedure based on a duration for the UE to move an antenna a change in pointing direction. Accounting for the duration in the change of association procedure may allow the UE to communicate using a target beam after switching beams without delay, which may improve communication latency (e.g., related to unaccounted for delay in changing the position of the antenna at the UE), among other advantages.

Based on implementing the change of association procedure based on a change in pointing direction duration for an antenna at the UE as described herein, a processor of a UE or a base station (e.g., a processor controlling the receiver 910, the communications manager 915, the transmitter 920, or any combination thereof) may reduce the impact or likelihood of inefficient resource utilization due to delays during change of association procedures (e.g., cell reselection procedures, beam switching procedures, handover procedures, or the like) while ensuring relatively efficient communications. For example, the change of association techniques described herein may leverage a control message or a capability report to determine a duration for the change of pointing angle of the antenna, which may realize power savings at the UE (e.g., due to improving communication latency and fewer failed change of association procedures), among other benefits.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a digital signal processor (DSP), an application-specific integrated circuit (ASIC), a field-programmable gate-array (FPGA) or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or any combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

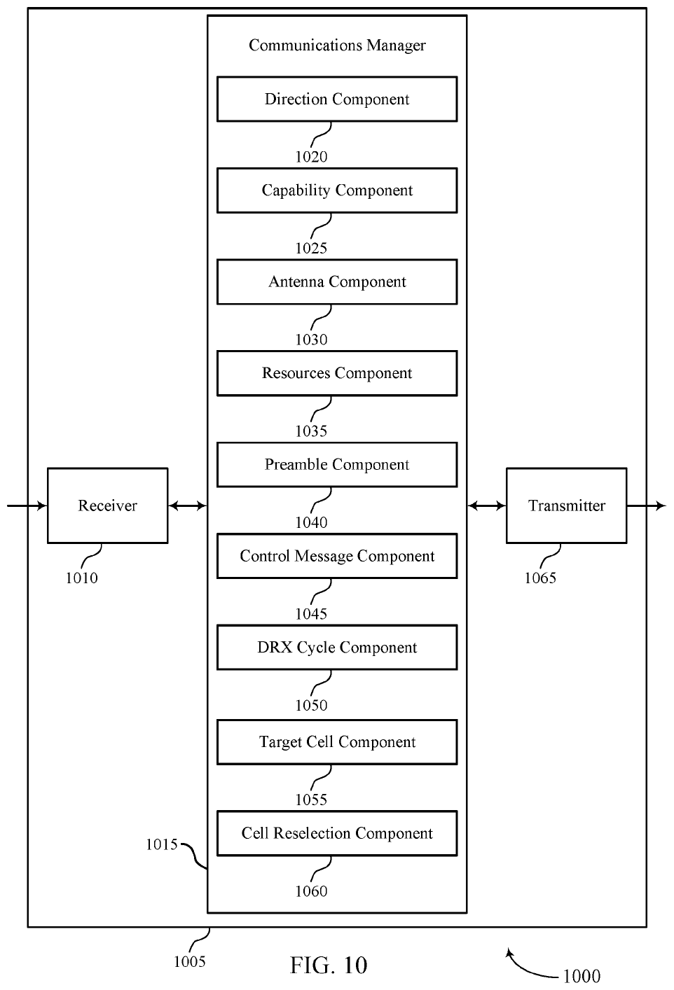

FIG. 10 shows a block diagram 1000 of a device 1005 that supports satellite tracking related methods in accordance with aspects of the present disclosure. The device 1005 may be an example of aspects of a device 905, or a UE 115 as described herein. The device 1005 may include a receiver 1010, a communications manager 1015, and a transmitter 1065. The device 1005 may also include a processor. Each of these components may be in communication with one another (e.g., via one or more buses).

The receiver 1010 may receive information such as packets, user data, or control information associated with various information channels (e.g., control channels, data channels, and information related to satellite tracking related methods, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a direction component 1020, a capability component 1025, an antenna component 1030, a resources component 1035, a preamble component 1040, a control message component 1045, a DRX cycle component 1050, a target cell component 1055, and a cell reselection component 1060. The communications manager 1015 may be an example of aspects of the communications manager 1210 described herein.

The direction component 1020 may determine a capability of the UE associated with moving an antenna during a duration from a first direction corresponding to a first beam for communicating with a network entity to a second direction corresponding to a second beam for communicating. The capability component 1025 may transmit, to the network entity, an indication of the capability associated with moving the antenna during the duration from the first direction to the second direction. The antenna component 1030 may move the antenna, during the duration, from the first direction to the second direction based on transmitting the indication of the capability.

The resources component 1035 may receive, from a network entity, a control message, the control message including an indication of one or more resources to use for a random access preamble associated with a random access procedure. The antenna component 1030 may determine, based on receiving the control message, a duration during which an antenna of the UE is to move from a first direction corresponding to a first beam for communicating with the network entity to a second direction corresponding to a second beam for communicating. The preamble component 1040 may transmit, after the duration, the random access preamble using the one or more resources.

The control message component 1045 may receive, from a network entity, a control message, the control message including an indication of a pattern of DRX cycles for a first beam for communicating with the network entity, each DRX cycle including an active reception duration and an inactive reception duration. The antenna component 1030 may move an antenna of the UE from a first direction corresponding to the first beam to a second direction corresponding to a second beam for communicating, where the first beam is associated with a first cell and the second beam is associated with a second cell. The DRX cycle component 1050 may communicate with the network entity during an active reception duration of at least one DRX cycle based on moving the antenna from the first direction to the second direction.

The capability component 1025 may identify information corresponding to one or more of a set of cells, the set of cells corresponding to one or more candidate network entities, the information associated with a capability of the UE corresponding to moving an antenna during a duration and a state of the UE. The target cell component 1055 may select, for a cell reselection procedure from a current cell and based on the information, a target cell from the set of cells, the target cell associated with a candidate network entity of the one or more candidate network entities. The cell reselection component 1060 may perform the cell reselection procedure to the target cell based on selecting the target cell from the set of cells and communicate with the candidate network entity based on the cell reselection procedure.

The transmitter 1065 may transmit signals generated by other components of the device 1005. In some examples, the transmitter 1065 may be collocated with a receiver 1010 in a transceiver module. For example, the transmitter 1065 may be an example of aspects of the transceiver 1220 described with reference to FIG. 12. The transmitter 1065 may utilize a single antenna or a set of antennas.

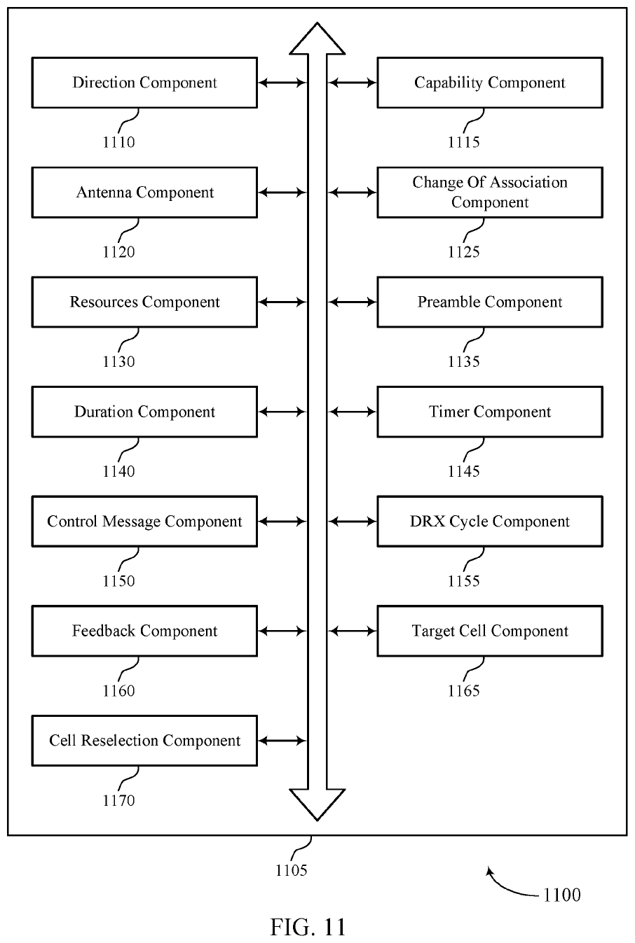

FIG. 11 shows a block diagram 1100 of a communications manager 1105 that supports satellite tracking related methods in accordance with aspects of the present disclosure. The communications manager 1105 may be an example of aspects of a communications manager 915, a communications manager 1015, or a communications manager 1210 described herein. The communications manager 1105 may include a direction component 1110, a capability component 1115, an antenna component 1120, a change of association component 1125, a resources component 1130, a preamble component 1135, a duration component 1140, a timer component 1145, a control message component 1150, a DRX cycle component 1155, a feedback component 1160, a target cell component 1165, and a cell reselection component 1170. Each of these modules may communicate, directly or indirectly, with one another (e.g., via one or more buses).

The direction component 1110 may determine a capability of the UE associated with moving an antenna during a duration from a first direction corresponding to a first beam for communicating with a network entity to a second direction corresponding to a second beam for communicating. The capability component 1115 may transmit, to the network entity, an indication of the capability associated with moving the antenna during the duration from the first direction to the second direction. The antenna component 1120 may move the antenna, during the duration, from the first direction to the second direction based on transmitting the indication of the capability.

In some examples, the direction component 1110 may receive an indication corresponding to the duration, the duration associated with a duration for the UE to steer the antenna based on a difference in one or more degrees between a first angle corresponding to the first direction and a second angle corresponding to the second direction. In some examples, the antenna component 1120 may determine an antenna type associated with the antenna, a number of antennas at the UE, a continuous tracking mode associated with the antenna, a step-wise tracking mode associated with the antenna, or any combination thereof.

The change of association component 1125 may determine to perform a change of association procedure from the network entity to a target network entity, where the second beam is for communicating with the target network entity. In some examples, the change of association component 1125 may communicate with the target network entity based on moving the antenna from the first direction to the second direction. In some cases, the change of association procedure is a handover between two cells. In some other cases, the change of association procedure is a beam switching operation within a same cell. In some cases, the antenna is an AESA or a mechanical motor steered antenna. In some cases, the UE and the network entity are associated with a non-terrestrial network, and where the network entity is a satellite.

The resources component 1130 may receive, from a network entity, a control message, the control message including an indication of one or more resources to use for a random access preamble associated with a random access procedure. In some examples, the antenna component 1120 may determine, based on receiving the control message, a duration during which an antenna of the UE is to move from a first direction corresponding to a first beam for communicating with the network entity to a second direction corresponding to a second beam for communicating. The preamble component 1135 may transmit, after the duration, the random access preamble using the one or more resources.

In some examples, the change of association component 1125 may determine to perform a change of association procedure from the network entity to a target network entity, where the second beam is for communicating with the target network entity. In some cases, the change of association procedure is a handover between two cells. In some other cases, the change of association procedure is a beam switching operation within a same cell. In some examples, the change of association component 1125 may receive an indication of the target network entity, the indication including location information of the target network entity, an identifier corresponding to the target network entity, or both. In some examples, the change of association component 1125 may transmit the random access preamble to the target network entity as part of the handover procedure, where the second beam is for communicating with the target network entity.

The duration component 1140 may receive, from the network entity, a downlink control channel order, the downlink control channel order including an indication of the duration, where transmitting the random access preamble after the duration is based on receiving the downlink control channel order. In some examples, the preamble component 1135 may determine an additional duration, the additional duration including an uplink channel preparation time, a BWP switching duration, an operational frequency range duration, or any combination thereof. In some examples, the preamble component 1135 may transmit the random access preamble based on the duration and the additional duration.

In some examples, the duration component 1140 may determine a given duration based on a capability of the UE to move the antenna of the UE and transmit the random access preamble concurrently. In some examples, the duration component 1140 may transmit the random access preamble after the given duration, where the given duration corresponds to the shorter of the duration and the additional duration. In some examples, the duration component 1140 may transmit the random access preamble after the duration and the additional duration.

In some examples, the duration component 1140 may receive an indication of the duration, the duration corresponding to a handover outage time, a duration for the UE to apply frequency compensation, a duration for frequency retuning, or any combination thereof. In some cases, the indication is a field in an RRC message.

The timer component 1145 may initiate a timer based on receiving the indication, the timer duration corresponding to the duration. In some examples, the timer component 1145 may transmit the random access preamble based on the timer duration. the control message may be an RRC message.

In some examples, the duration component 1140 may determine the duration based on a handover outage time, a duration for the UE to apply frequency compensation, a duration for frequency retuning, or any combination thereof. In some examples, the duration component 1140 may determine the handover outage time based on ephemeris information associated with one or more network entities, a capability of the UE associated with moving the antenna, or any combination thereof. In some examples, the preamble component 1135 may receive an index corresponding to the random access preamble, one or more random access occasions for transmitting the random access preamble, or any combination thereof.

In some examples, the duration component 1140 may receive a DCI message, a MAC-CE, or both, the DCI message, the MAC-CE, or both including an index corresponding to the random access preamble, an indication of one or more random access occasions, or both. In some cases, the UE and the network entity are associated with a non-terrestrial network, and where the network entity is a satellite.

The control message component 1150 may receive, from a network entity, a control message, the control message including an indication of a pattern of DRX cycles for a first beam for communicating with the network entity, each DRX cycle including an active reception duration and an inactive reception duration. In some examples, the antenna component 1120 may move an antenna of the UE from a first direction corresponding to the first beam to a second direction corresponding to a second beam for communicating, where the first beam is associated with a first cell and the second beam is associated with a second cell. The DRX cycle component 1155 may communicate with the network entity during an active reception duration of at least one DRX cycle based on moving the antenna from the first direction to the second direction.

In some examples, the timer component 1145 may activate the timer based on receiving the indication. In some examples, the timer component 1145 may wake up based on the timer expiring. In some examples, the timer component 1145 may receive a beam switching command, where moving the antenna from the first direction to the second direction is based on receiving the beam switching command. The feedback component 1160 may transmit, to the network entity, a feedback message corresponding to receiving the beam switching command. In some examples, the antenna component 1120 may perform a beam switching operation from a first BWP associated with the first beam to a second BWP associated with the second beam based on receiving the beam switching command. In some cases, the timer corresponds to a handover outage time, a duration for the UE to apply frequency compensation, a duration for frequency retuning, or any combination thereof.

In some examples, the timer component 1145 may activate the timer. In some examples, the timer component 1145 may wake up based on the timer expiring. In some examples, the timer component 1145 may determine to perform a change of association procedure based on the first cell being different than the second cell. In some examples, the timer component 1145 may determine to transmit, to a network entity associated with the second beam, an indication of the change of associated procedure, where the indication includes a random access preamble, a scheduling request, or both. In some cases, the change of association procedure is a handover procedure from a current cell associated with the network entity to a target cell associated with a target network entity, where the second beam is for communicating with the target network entity. In some cases, the timer corresponds to a duration for the UE to enter a coverage area associated with the second beam, a handover outage time, a duration for the UE to apply frequency compensation, a duration for frequency retuning, or any combination thereof.

In some cases, the control message includes an indication of the active reception duration, the inactive reception duration, a DRX inactivity timer, a DRX slot offset, a DRX long cycle, a start offset of the DRX long cycle, a DRX short cycle, a DRX short cycle timer, an initial BWP configuration of the second beam, or any combination thereof. In some cases, the UE and the network entity are associated with a non-terrestrial network, and where the network entity is a satellite.

In some examples, the capability component 1115 may identify information corresponding to one or more of a set of cells, the set of cells corresponding to one or more candidate network entities, the information associated with a capability of the UE corresponding to moving an antenna during a duration and a state of the UE. The target cell component 1165 may select, for a cell reselection procedure from a current cell and based on the information, a target cell from the set of cells, the target cell associated with a candidate network entity of the one or more candidate network entities. The cell reselection component 1170 may perform the cell reselection procedure to the target cell based on selecting the target cell from the set of cells. In some examples, the cell reselection component 1170 may communicate with the candidate network entity based on the cell reselection procedure.

In some examples, the capability component 1115 may receive, from a network entity, an indication of a cell identifier for each cell of the set of cells, location information corresponding to the one or more candidate network entities, relative speed information corresponding to the one or more candidate network entities, orbital information corresponding to the one or more candidate network entities, a random access preamble for each cell of the set of cells, a priority associated with the one or more candidate network entities, or any combination thereof, where identifying the information is based on the receiving. In some cases, the information includes location information associated with each candidate network entity of the one or more candidate network entities, a difference measured in angles corresponding to moving the antenna from a first direction associated with the current cell to a second direction associated with the target cell, a speed corresponding to moving the antenna from the first direction to the second direction, an indication of a cell identifier for each cell of the set of cells, a priority associated with the one or more candidate network entities, a duration corresponding to a QoS requirement at the UE, one or more measurements corresponding to a link quality between the UE and the one or more candidate network entities, or any combination thereof.

In some examples, the capability component 1115 may determine a capability of the UE to perform the cell reselection procedure from the current cell to the target cell, where performing the cell reselection procedure is based on determining the capability of the UE to perform the cell reselection procedure.

FIG. 12 shows a diagram of a system 1200 including a device 1205 that supports satellite tracking related methods in accordance with aspects of the present disclosure. The device 1205 may be an example of or include the components of device 905, device 1005, or a UE 115 as described herein. The device 1205 may include components for bi-directional voice and data communications including components for transmitting and receiving communications, including a communications manager 1210, an I/O controller 1215, a transceiver 1220, an antenna 1225, memory 1230, and a processor 1240. These components may be in electronic communication via one or more buses (e.g., bus 1245).

The communications manager 1210 may determine a capability of the UE associated with moving an antenna during a duration from a first direction corresponding to a first beam for communicating with a network entity to a second direction corresponding to a second beam for communicating, transmit, to the network entity, an indication of the capability associated with moving the antenna during the duration from the first direction to the second direction, and move the antenna, during the duration, from the first direction to the second direction based on transmitting the indication of the capability.

The communications manager 1210 may also receive, from a network entity, a control message, the control message including an indication of one or more resources to use for a random access preamble associated with a random access procedure, determine, based on receiving the control message, a duration during which an antenna of the UE is to move from a first direction corresponding to a first beam for communicating with the network entity to a second direction corresponding to a second beam for communicating, and transmit, after the duration, the random access preamble using the one or more resources.

The communications manager 1210 may also receive, from a network entity, a control message, the control message including an indication of a pattern of DRX cycles for a first beam for communicating with the network entity, each DRX cycle including an active reception duration and an inactive reception duration, move an antenna of the UE from a first direction corresponding to the first beam to a second direction corresponding to a second beam for communicating, where the first beam is associated with a first cell and the second beam is associated with a second cell, and communicate with the network entity during an active reception duration of at least one DRX cycle based on moving the antenna from the first direction to the second direction.

The communications manager 1210 may also identify information corresponding to one or more of a set of cells, the set of cells corresponding to one or more candidate network entities, the information associated with a capability of the UE corresponding to moving an antenna during a duration and a state of the UE, select, for a cell reselection procedure from a current cell and based on the information, a target cell from the set of cells, the target cell associated with a candidate network entity of the one or more candidate network entities, perform the cell reselection procedure to the target cell based on selecting the target cell from the set of cells, and communicate with the candidate network entity based on the cell reselection procedure.

The I/O controller 1215 may manage input and output signals for the device 1205. The I/O controller 1215 may also manage peripherals not integrated into the device 1205. In some cases, the I/O controller 1215 may represent a physical connection or port to an external peripheral. In some cases, the I/O controller 1215 may utilize an operating system such as iOS®, ANDROID®, MS-DOS®, MS-WINDOWS®, OS/2®, UNIX®, LINUX®, or another known operating system. In other cases, the I/O controller 1215 may represent or interact with a modem, a keyboard, a mouse, a touchscreen, or a similar device. In some cases, the I/O controller 1215 may be implemented as part of a processor. In some cases, a user may interact with the device 1205 via the I/O controller 1215 or via hardware components controlled by the I/O controller 1215.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include random-access memory (RAM) and read-only memory (ROM). The memory 1230 may store computer-readable, computer-executable code 1235 including instructions that, when executed, cause the processor to perform various functions described herein. In some cases, the memory 1230 may contain, among other things, a basic I/O system (BIOS) which may control basic hardware or software operation such as the interaction with peripheral components or devices.

The processor 1240 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1240 may be configured to operate a memory array using a memory controller. In other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting satellite tracking related methods).

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

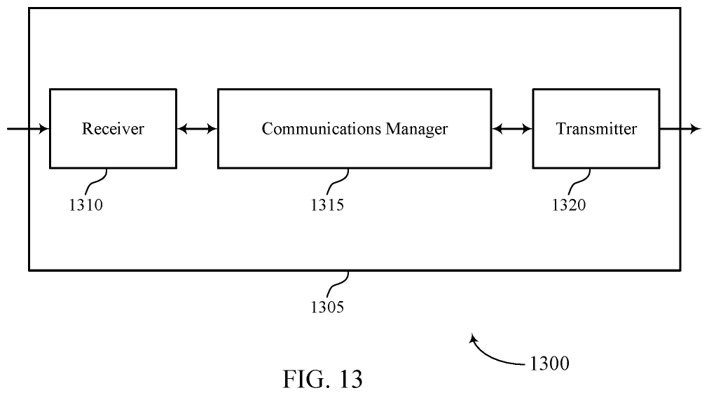

FIG. 13 shows a block diagram 1300 of a device 1305 that supports satellite tracking related methods in accordance with aspects of the present disclosure. The device 1305 may be an example of aspects of a network entity as described herein. The device 1305 may include a receiver 1310, a communications manager 1315, and a transmitter 1320. The device 1305 may also include a processor. Each of these components may be in communication with one another (e.g., via one or more buses).

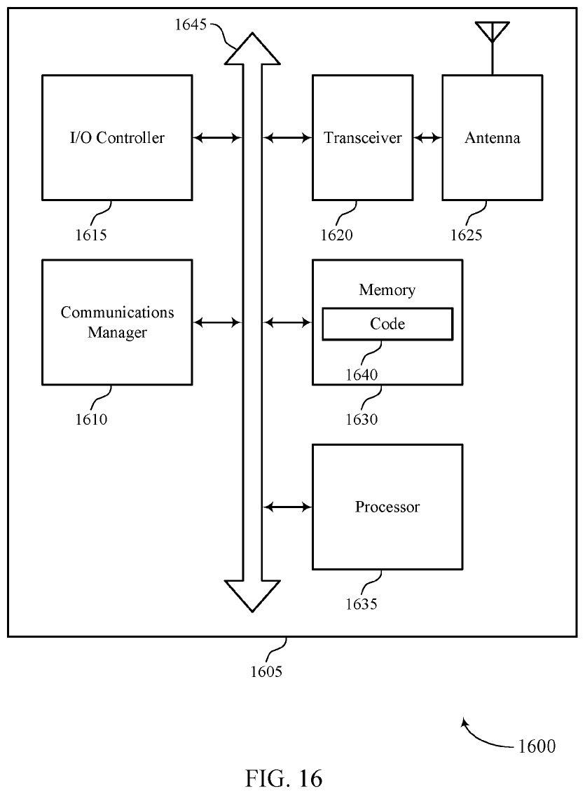

The receiver 1310 may receive information such as packets, user data, or control information associated with various information channels (e.g., control channels, data channels, and information related to satellite tracking related methods, etc.). Information may be passed on to other components of the device 1305. The receiver 1310 may be an example of aspects of the transceiver 1620 described with reference to FIG. 16. The receiver 1310 may utilize a single antenna or a set of antennas.

The communications manager 1315 may receive, from a UE, an indication of a capability of the UE associated with moving an antenna during a duration from a first direction corresponding to a first beam for communicating with a second network entity to a second direction corresponding to a second beam for communicating with the first network entity and communicate with the UE using the second beam based on the UE moving the antenna, during the duration, from the first direction to the second direction based on the capability.

The communications manager 1315 may also transmit, to a UE, a control message, the control message including an indication of one or more resources to use for a random access preamble associated with a random access procedure and receive, during the one or more resources and after a duration during which an antenna of the UE is to move from a first direction corresponding to a first beam for communicating with a second network entity to a second direction corresponding to a second beam for communicating with the first network entity, the random access preamble.

The communications manager 1315 may also transmit, to a UE, a control message, the control message including an indication of a pattern of DRX cycle for a first beam for communicating with the network entity, each DRX cycle including an active reception duration and an inactive reception duration and communicate with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell.

The communications manager 1315 may also determine information corresponding to one or more of a set of cells, the set of cells corresponding to one or more candidate network entities, the information associated with a capability of the UE corresponding to moving an antenna during a duration and a state of the UE, transmit, to the UE, the information for a cell reselection procedure from a current cell associated with the network entity to a target cell associated with a candidate network entity of the one or more candidate network entities, and refrain from communicating with the UE based on the UE performing the cell reselection procedure. The communications manager 1315 may be an example of aspects of the communications manager 1610 described herein.

The communications manager 1315, or its sub-components, may be implemented in hardware, code (e.g., software or firmware) executed by a processor, or any combination thereof. If implemented in code executed by a processor, the functions of the communications manager 1315, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The communications manager 1315, or its sub-components, may be physically located at various positions, including being distributed such that portions of functions are implemented at different physical locations by one or more physical components. In some examples, the communications manager 1315, or its sub-components, may be a separate and distinct component in accordance with various aspects of the present disclosure. In some examples, the communications manager 1315, or its sub-components, may be combined with one or more other hardware components, including but not limited to an input/output (I/O) component, a transceiver, a network server, another computing device, one or more other components described in the present disclosure, or any combination thereof in accordance with various aspects of the present disclosure.

The transmitter 1320 may transmit signals generated by other components of the device 1305. In some examples, the transmitter 1320 may be collocated with a receiver 1310 in a transceiver module. For example, the transmitter 1320 may be an example of aspects of the transceiver 1620 described with reference to FIG. 16. The transmitter 1320 may utilize a single antenna or a set of antennas.

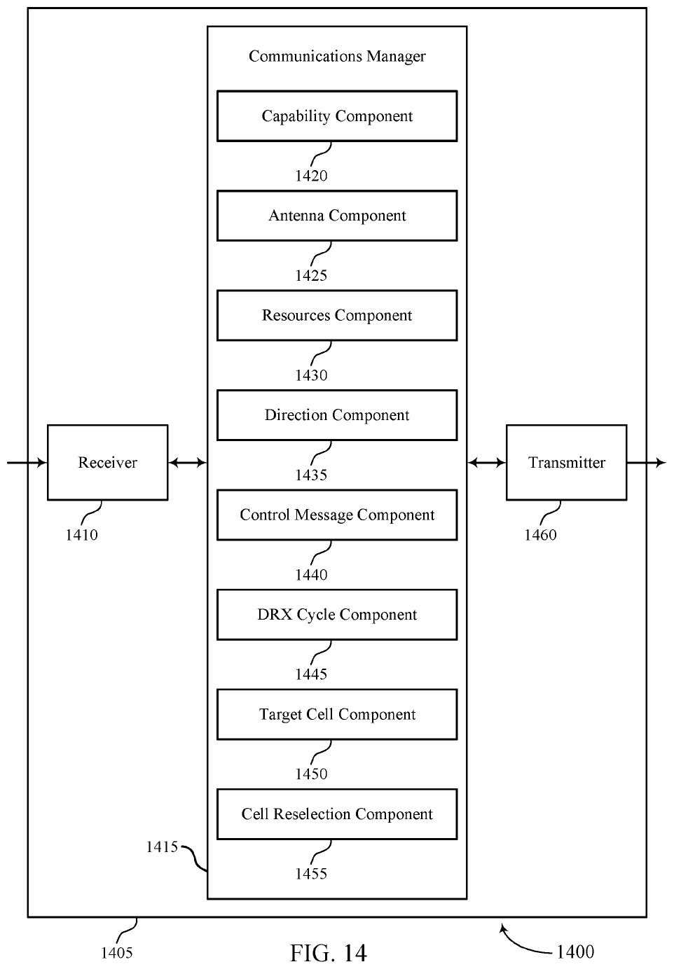

FIG. 14 shows a block diagram 1400 of a device 1405 that supports satellite tracking related methods in accordance with aspects of the present disclosure. The device 1405 may be an example of aspects of a device 1305 or a network entity 120 as described herein. The device 1405 may include a receiver 1410, a communications manager 1415, and a transmitter 1460. The device 1405 may also include a processor. Each of these components may be in communication with one another (e.g., via one or more buses).

The receiver 1410 may receive information such as packets, user data, or control information associated with various information channels (e.g., control channels, data channels, and information related to satellite tracking related methods, etc.). Information may be passed on to other components of the device 1405. The receiver 1410 may be an example of aspects of the transceiver 1620 described with reference to FIG. 16. The receiver 1410 may utilize a single antenna or a set of antennas.

The communications manager 1415 may be an example of aspects of the communications manager 1315 as described herein. The communications manager 1415 may include a capability component 1420, an antenna component 1425, a resources component 1430, a direction component 1435, a control message component 1440, a DRX cycle component 1445, a target cell component 1450, and a cell reselection component 1455. The communications manager 1415 may be an example of aspects of the communications manager 1610 described herein.

The capability component 1420 may receive, from a UE, an indication of a capability of the UE associated with moving an antenna during a duration from a first direction corresponding to a first beam for communicating with a second network entity to a second direction corresponding to a second beam for communicating with the first network entity. The antenna component 1425 may communicate with the UE using the second beam based on the UE moving the antenna, during the duration, from the first direction to the second direction based on the capability.

The resources component 1430 may transmit, to a UE, a control message, the control message including an indication of one or more resources to use for a random access preamble associated with a random access procedure. The direction component 1435 may receive, during the one or more resources and after a duration during which an antenna of the UE is to move from a first direction corresponding to a first beam for communicating with a second network entity to a second direction corresponding to a second beam for communicating with the first network entity, the random access preamble.

The control message component 1440 may transmit, to a UE, a control message, the control message including an indication of a pattern of DRX cycle for a first beam for communicating with the network entity, each DRX cycle including an active reception duration and an inactive reception duration. The DRX cycle component 1445 may communicate with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell.

The capability component 1420 may determine information corresponding to one or more of a set of cells, the set of cells corresponding to one or more candidate network entities, the information associated with a capability of the UE corresponding to moving an antenna during a duration and a state of the UE. The target cell component 1450 may transmit, to the UE, the information for a cell reselection procedure from a current cell associated with the network entity to a target cell associated with a candidate network entity of the one or more candidate network entities. The cell reselection component 1455 may refrain from communicating with the UE based on the UE performing the cell reselection procedure.

The transmitter 1420 may transmit signals generated by other components of the device 1405. In some examples, the transmitter 1420 may be collocated with a receiver 1410 in a transceiver module. For example, the transmitter 1420 may be an example of aspects of the transceiver 1620 described with reference to FIG. 16. The transmitter 1420 may utilize a single antenna or a set of antennas.

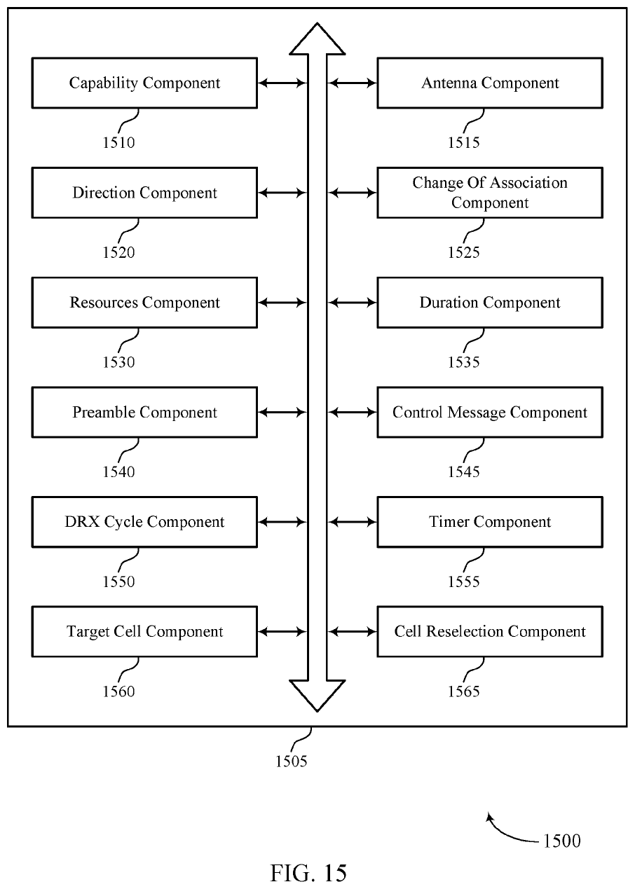

FIG. 15 shows a block diagram 1500 of a communications manager 1505 that supports satellite tracking related methods in accordance with aspects of the present disclosure. The communications manager 1505 may be an example of aspects of a communications manager 1315, a communications manager 1415, or a communications manager 1610 described herein. The communications manager 1505 may include a capability component 1510, an antenna component 1515, a direction component 1520, a change of association component 1525, a resources component 1530, a duration component 1535, a preamble component 1540, a control message component 1545, a DRX cycle component 1550, a timer component 1555, a target cell component 1560, and a cell reselection component 1565. Each of these modules may communicate, directly or indirectly, with one another (e.g., via one or more buses).

The capability component 1510 may receive, from a UE, an indication of a capability of the UE associated with moving an antenna during a duration from a first direction corresponding to a first beam for communicating with a second network entity to a second direction corresponding to a second beam for communicating with the first network entity. The antenna component 1515 may communicate with the UE using the second beam based on the UE moving the antenna, during the duration, from the first direction to the second direction based on the capability.

In some examples, the direction component 1520 may transmit, to the UE, an indicator corresponding to the duration, the duration associated with a duration for the UE to steer the antenna based on a difference in degrees between a first angle corresponding to the first direction and a second angle corresponding to the second direction. In some cases, the change of association component 1525 may determine the first network entity is a target network entity in a change of association procedure. In some examples, the change of association component 1525 may determine the change of association procedure is a handover between two cells. In some other cases, the change of association procedure is a beam switching operation within a same cell. In some cases, the antenna is an AESA or a mechanical motor steered antenna. In some cases, the UE and the first network entity are associated with a non-terrestrial network, and where the network entity is a satellite.

The resources component 1530 may transmit, to a UE, a control message, the control message including an indication of one or more resources to use for a random access preamble associated with a random access procedure. The direction component 1520 may receive, during the one or more resources and after a duration during which an antenna of the UE is to move from a first direction corresponding to a first beam for communicating with a second network entity to a second direction corresponding to a second beam for communicating with the first network entity, the random access preamble.

The duration component 1535 may transmit, to the UE, a downlink control channel order, the downlink control channel order including an indication of the duration, where receiving the random access preamble after the duration is based on transmitting the downlink control channel order. In some examples, the resources component 1530 may transmit a DCI message, a MAC-CE, or both, the DCI message, the MAC-CE, or both including an index corresponding to the random access preamble, an indication of one or more random access occasions, or both.

The preamble component 1540 may receive the random access preamble based on the duration and an additional duration, the additional duration including an uplink channel preparation time, a BWP switching duration, an operational frequency range duration, or any combination thereof. In some examples, the preamble component 1540 may receive the random access preamble after a given duration based on a capability of the UE to move the antenna of the UE and transmit the random access preamble concurrently, where the given duration corresponds to the shorter of the duration and the additional duration. In some examples, the preamble component 1540 may receive the random access preamble after the duration and the additional duration.

In some cases, the first network entity is a target network entity in a change of association procedure. In some cases, the change of association procedure is a handover between two cells. In some other cases, the change of association procedure is a beam switching operation within a same cell. In some examples, the change of association component 1525 may transmit, to the UE, an indication of location information of the target network entity, an identifier corresponding to the target network entity, or both. In some examples, the control message component 1545 may determine the control message is an RRC message.

In some examples, the duration component 1535 may transmit an indication of the duration, the duration corresponding to a handover outage time, a duration for the UE to apply frequency compensation, a duration for frequency retuning, or any combination thereof. In some examples, the resources component 1530 may determine the indication is a field in an RRC message.

In some examples, the preamble component 1540 may transmit an index corresponding to the random access preamble, one or more random access occasions for transmitting the random access preamble, or any combination thereof.

The control message component 1545 may transmit, to a UE, a control message, the control message including an indication of a pattern of DRX cycle for a first beam for communicating with the network entity, each DRX cycle including an active reception duration and an inactive reception duration. The DRX cycle component 1550 may communicate with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell.

The timer component 1555 may transmit a beam switching command based on the timer expiring at the UE, where the UE moves the antenna from the first direction to the second direction based on transmitting the beam switching command. In some examples, the timer component 1555 may receive, from the UE, a feedback message corresponding to transmitting the beam switching command. In some cases, the change of association procedure is a handover procedure from a current cell associated with the network entity to a target cell associated with a target network entity, where the second beam is for communicating with the target network entity. In some cases, the timer corresponds to a duration for the UE to enter a coverage area associated with the second beam, a handover outage time, a duration for the UE to apply frequency compensation, a duration for frequency retuning, or any combination thereof. In some cases, the control message includes an indication of the active reception duration, the inactive reception duration, a DRX inactivity timer, a DRX slot offset, a DRX long cycle, a start offset of the DRX long cycle, a DRX short cycle, a DRX short cycle timer, an initial BWP configuration of the second beam, or any combination thereof.

In some examples, the capability component 1510 may determine information corresponding to one or more of a set of cells, the set of cells corresponding to one or more candidate network entities, the information associated with a capability of the UE corresponding to moving an antenna during a duration and a state of the UE. The target cell component 1560 may transmit, to the UE, the information for a cell reselection procedure from a current cell associated with the network entity to a target cell associated with a candidate network entity of the one or more candidate network entities. The cell reselection component 1565 may refrain from communicating with the UE based on the UE performing the cell reselection procedure.

In some examples, the capability component 1510 may determine an indication of a cell identifier for each cell of the set of cells, location information corresponding to the one or more candidate network entities, relative speed information corresponding to the one or more candidate network entities, orbital information corresponding to the one or more candidate network entities, a random access preamble for each cell of the set of cells, a priority associated with the one or more candidate network entities, or any combination thereof. In some examples, the capability component 1510 may receive, from the UE, an indication of a capability of the UE to perform the cell reselection procedure from the current cell to the target cell. In some examples, the change of association component 1525 may transmit, to the UE and based on the timer expiring, an indication to perform a change of association procedure based on the first cell being different than the second cell. In some cases, the timer corresponds to a handover outage time, a duration for the UE to apply frequency compensation, a duration for frequency retuning, or any combination thereof.

FIG. 16 shows a diagram of a system 1600 including a device 1605 that supports satellite tracking related methods in accordance with aspects of the present disclosure. The device 1605 may be an example of or include the components of device 1305, device 1405, or a network entity as described herein. The device 1605 may include components for bi-directional voice and data communications including components for transmitting and receiving communications, including a communications manager 1610, an I/O controller 1615, a transceiver 1620, an antenna 1625, memory 1630, and a processor 1635. These components may be in electronic communication via one or more buses (e.g., bus 1645).

The communications manager 1610 may receive, from a UE, an indication of a capability of the UE associated with moving an antenna during a duration from a first direction corresponding to a first beam for communicating with a second network entity to a second direction corresponding to a second beam for communicating with the first network entity and communicate with the UE using the second beam based on the UE moving the antenna, during the duration, from the first direction to the second direction based on the capability.

The communications manager 1610 may also transmit, to a UE, a control message, the control message including an indication of one or more resources to use for a random access preamble associated with a random access procedure and receive, during the one or more resources and after a duration during which an antenna of the UE is to move from a first direction corresponding to a first beam for communicating with a second network entity to a second direction corresponding to a second beam for communicating with the first network entity, the random access preamble.

The communications manager 1610 may also transmit, to a UE, a control message, the control message including an indication of a pattern of DRX cycle for a first beam for communicating with the network entity, each DRX cycle including an active reception duration and an inactive reception duration and communicate with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell.

The communications manager 1610 may also determine information corresponding to one or more of a set of cells, the set of cells corresponding to one or more candidate network entities, the information associated with a capability of the UE corresponding to moving an antenna during a duration and a state of the UE, transmit, to the UE, the information for a cell reselection procedure from a current cell associated with the network entity to a target cell associated with a candidate network entity of the one or more candidate network entities, and refrain from communicating with the UE based on the UE performing the cell reselection procedure.

The I/O controller 1615 may manage input and output signals for the device 1605. The I/O controller 1615 may also manage peripherals not integrated into the device 1605. In some cases, the I/O controller 1615 may represent a physical connection or port to an external peripheral. In some cases, the I/O controller 1615 may utilize an operating system such as iOS®, ANDROID®, MS-DOS®, MS-WINDOWS®, OS/2®, UNIX®, LINUX®, or another known operating system. In other cases, the I/O controller 1615 may represent or interact with a modem, a keyboard, a mouse, a touchscreen, or a similar device. In some cases, the I/O controller 1615 may be implemented as part of a processor. In some cases, a user may interact with the device 1605 via the I/O controller 1615 or via hardware components controlled by the I/O controller 1615.

The transceiver 1620 may communicate bi-directionally, via one or more antennas, wired, or wireless links as described above. For example, the transceiver 1620 may represent a wireless transceiver and may communicate bi-directionally with another wireless transceiver. The transceiver 1620 may also include a modem to modulate the packets and provide the modulated packets to the antennas for transmission, and to demodulate packets received from the antennas.

In some cases, the wireless device may include a single antenna 1625. However, in some cases the device may have more than one antenna 1625, which may be capable of concurrently transmitting or receiving multiple wireless transmissions.

The memory 1630 may include RAM and ROM. The memory 1630 may store computer-readable, computer-executable code 1640 including instructions that, when executed, cause the processor to perform various functions described herein. In some cases, the memory 1630 may contain, among other things, a BIOS which may control basic hardware or software operation such as the interaction with peripheral components or devices.

The processor 1635 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1635 may be configured to operate a memory array using a memory controller. In other cases, a memory controller may be integrated into the processor 1635. The processor 1635 may be configured to execute computer-readable instructions stored in a memory (e.g., the memory 1630) to cause the device 1605 to perform various functions (e.g., functions or tasks supporting satellite tracking related methods).

The code 1640 may include instructions to implement aspects of the present disclosure, including instructions to support wireless communications. The code 1640 may be stored in a non-transitory computer-readable medium such as system memory or other type of memory. In some cases, the code 1640 may not be directly executable by the processor 1635 but may cause a computer (e.g., when compiled and executed) to perform functions described herein.

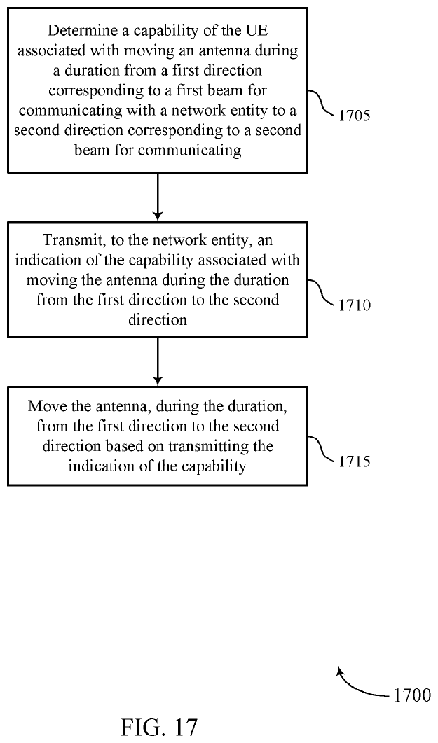

FIG. 17 shows a flowchart illustrating a method 1700 that supports satellite tracking related methods in accordance with aspects of the present disclosure. The operations of method 1700 may be implemented by a UE 115 or its components as described herein. For example, the operations of method 1700 may be performed by a communications manager as described with reference to FIGS. 9 through 12. In some examples, a UE may execute a set of instructions to control the functional elements of the UE to perform the functions described below. Additionally or alternatively, a UE may perform aspects of the functions described below using special-purpose hardware.

At 1705, the UE may determine a capability of the UE associated with moving an antenna during a duration from a first direction corresponding to a first beam for communicating with a network entity to a second direction corresponding to a second beam for communicating. The operations of 1705 may be performed according to the methods described herein. In some examples, aspects of the operations of 1705 may be performed by a direction component as described with reference to FIGS. 9 through 12.

At 1710, the UE may transmit, to the network entity, an indication of the capability associated with moving the antenna during the duration from the first direction to the second direction. The operations of 1710 may be performed according to the methods described herein. In some examples, aspects of the operations of 1710 may be performed by a capability component as described with reference to FIGS. 9 through 12.

At 1715, the UE may move the antenna, during the duration, from the first direction to the second direction based on transmitting the indication of the capability. The operations of 1715 may be performed according to the methods described herein. In some examples, aspects of the operations of 1715 may be performed by an antenna component as described with reference to FIGS. 9 through 12.

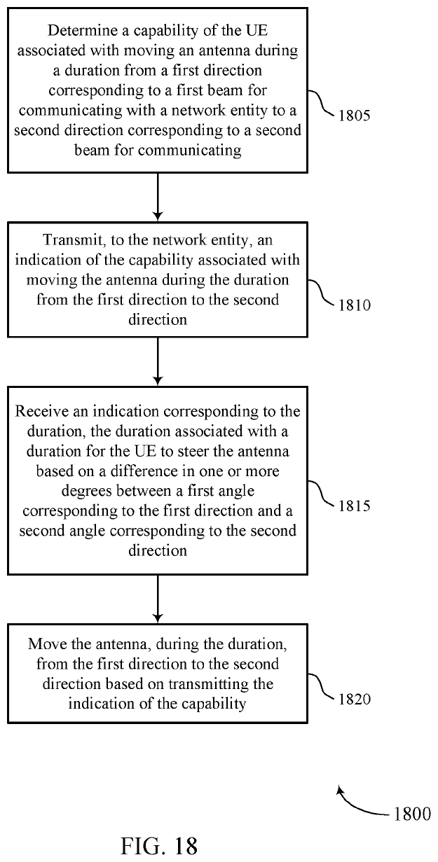

FIG. 18 shows a flowchart illustrating a method 1800 that supports satellite tracking related methods in accordance with aspects of the present disclosure. The operations of method 1800 may be implemented by a UE 115 or its components as described herein. For example, the operations of method 1800 may be performed by a communications manager as described with reference to FIGS. 9 through 12. In some examples, a UE may execute a set of instructions to control the functional elements of the UE to perform the functions described below. Additionally or alternatively, a UE may perform aspects of the functions described below using special-purpose hardware.

At 1805, the UE may determine a capability of the UE associated with moving an antenna during a duration from a first direction corresponding to a first beam for communicating with a network entity to a second direction corresponding to a second beam for communicating. The operations of 1805 may be performed according to the methods described herein. In some examples, aspects of the operations of 1805 may be performed by a direction component as described with reference to FIGS. 9 through 12.

At 1810, the UE may transmit, to the network entity, an indication of the capability associated with moving the antenna during the duration from the first direction to the second direction. The operations of 1810 may be performed according to the methods described herein. In some examples, aspects of the operations of 1810 may be performed by a capability component as described with reference to FIGS. 9 through 12.

At 1815, the UE may receive an indication corresponding to the duration, the duration associated with a duration for the UE to steer the antenna based on a difference in one or more degrees between a first angle corresponding to the first direction and a second angle corresponding to the second direction. The operations of 1815 may be performed according to the methods described herein. In some examples, aspects of the operations of 1815 may be performed by a direction component as described with reference to FIGS. 9 through 12.

At 1820, the UE may move the antenna, during the duration, from the first direction to the second direction based on transmitting the indication of the capability. The operations of 1820 may be performed according to the methods described herein. In some examples, aspects of the operations of 1820 may be performed by an antenna component as described with reference to FIGS. 9 through 12.

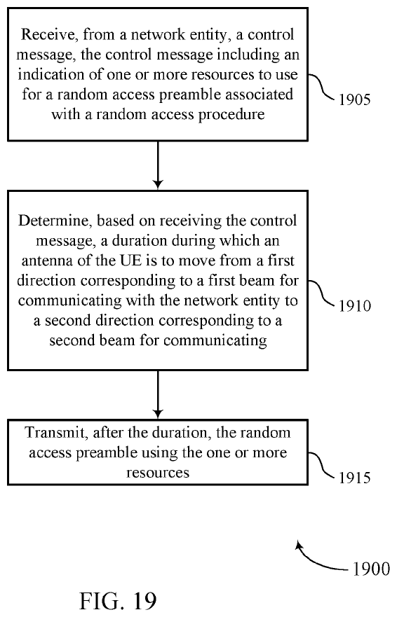

FIG. 19 shows a flowchart illustrating a method 1900 that supports satellite tracking related methods in accordance with aspects of the present disclosure. The operations of method 1900 may be implemented by a UE 115 or its components as described herein. For example, the operations of method 1900 may be performed by a communications manager as described with reference to FIGS. 9 through 12. In some examples, a UE may execute a set of instructions to control the functional elements of the UE to perform the functions described below. Additionally or alternatively, a UE may perform aspects of the functions described below using special-purpose hardware.

At 1905, the UE may receive, from a network entity, a control message, the control message including an indication of one or more resources to use for a random access preamble associated with a random access procedure. The operations of 1905 may be performed according to the methods described herein. In some examples, aspects of the operations of 1905 may be performed by a resources component as described with reference to FIGS. 9 through 12.

At 1910, the UE may determine, based on receiving the control message, a duration during which an antenna of the UE is to move from a first direction corresponding to a first beam for communicating with the network entity to a second direction corresponding to a second beam for communicating. The operations of 1910 may be performed according to the methods described herein. In some examples, aspects of the operations of 1910 may be performed by an antenna component as described with reference to FIGS. 9 through 12.

At 1915, the UE may transmit, after the duration, the random access preamble using the one or more resources. The operations of 1915 may be performed according to the methods described herein. In some examples, aspects of the operations of 1915 may be performed by a preamble component as described with reference to FIGS. 9 through 12.

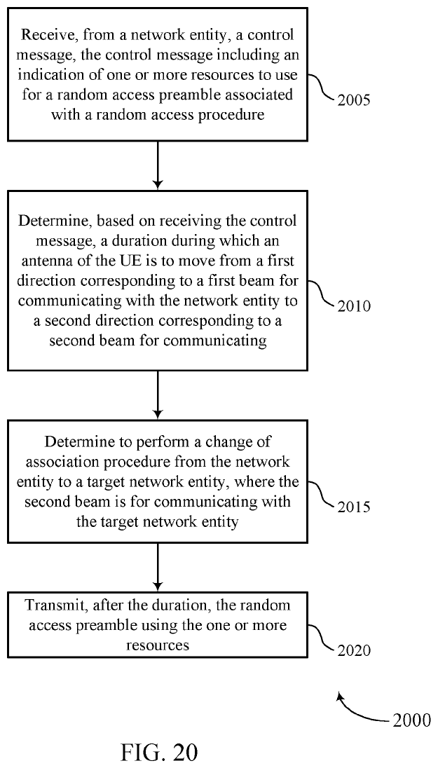

FIG. 20 shows a flowchart illustrating a method 2000 that supports satellite tracking related methods in accordance with aspects of the present disclosure. The operations of method 2000 may be implemented by a UE 115 or its components as described herein. For example, the operations of method 2000 may be performed by a communications manager as described with reference to FIGS. 9 through 12. In some examples, a UE may execute a set of instructions to control the functional elements of the UE to perform the functions described below. Additionally or alternatively, a UE may perform aspects of the functions described below using special-purpose hardware.

At 2005, the UE may receive, from a network entity, a control message, the control message including an indication of one or more resources to use for a random access preamble associated with a random access procedure. The operations of 2005 may be performed according to the methods described herein. In some examples, aspects of the operations of 2005 may be performed by a resources component as described with reference to FIGS. 9 through 12.

At 2010, the UE may determine, based on receiving the control message, a duration during which an antenna of the UE is to move from a first direction corresponding to a first beam for communicating with the network entity to a second direction corresponding to a second beam for communicating. The operations of 2010 may be performed according to the methods described herein. In some examples, aspects of the operations of 2010 may be performed by an antenna component as described with reference to FIGS. 9 through 12.

At 2015, the UE may determine to perform a change of association procedure from the network entity to a target network entity, where the second beam is for communicating with the target network entity. The operations of 2015 may be performed according to the methods described herein. In some examples, aspects of the operations of 2015 may be performed by a change of association component as described with reference to FIGS. 9 through 12.

At 2020, the UE may transmit, after the duration, the random access preamble using the one or more resources. The operations of 2020 may be performed according to the methods described herein. In some examples, aspects of the operations of 2020 may be performed by a preamble component as described with reference to FIGS. 9 through 12.

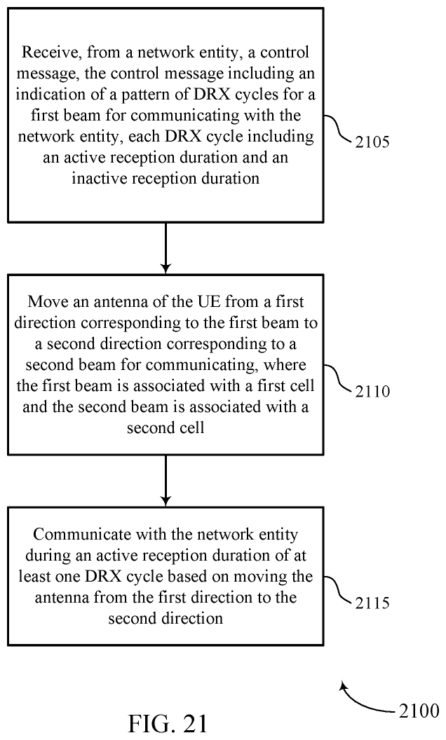

FIG. 21 shows a flowchart illustrating a method 2100 that supports satellite tracking related methods in accordance with aspects of the present disclosure. The operations of method 2100 may be implemented by a UE 115 or its components as described herein. For example, the operations of method 2100 may be performed by a communications manager as described with reference to FIGS. 9 through 12. In some examples, a UE may execute a set of instructions to control the functional elements of the UE to perform the functions described below. Additionally or alternatively, a UE may perform aspects of the functions described below using special-purpose hardware.

At 2105, the UE may receive, from a network entity, a control message, the control message including an indication of a pattern of DRX cycles for a first beam for communicating with the network entity, each DRX cycle including an active reception duration and an inactive reception duration. The operations of 2105 may be performed according to the methods described herein. In some examples, aspects of the operations of 2105 may be performed by a control message component as described with reference to FIGS. 9 through 12.

At 2110, the UE may move an antenna of the UE from a first direction corresponding to the first beam to a second direction corresponding to a second beam for communicating, where the first beam is associated with a first cell and the second beam is associated with a second cell. The operations of 2110 may be performed according to the methods described herein. In some examples, aspects of the operations of 2110 may be performed by an antenna component as described with reference to FIGS. 9 through 12.

At 2115, the UE may communicate with the network entity during an active reception duration of at least one DRX cycle based on moving the antenna from the first direction to the second direction. The operations of 2115 may be performed according to the methods described herein. In some examples, aspects of the operations of 2115 may be performed by a DRX cycle component as described with reference to FIGS. 9 through 12.

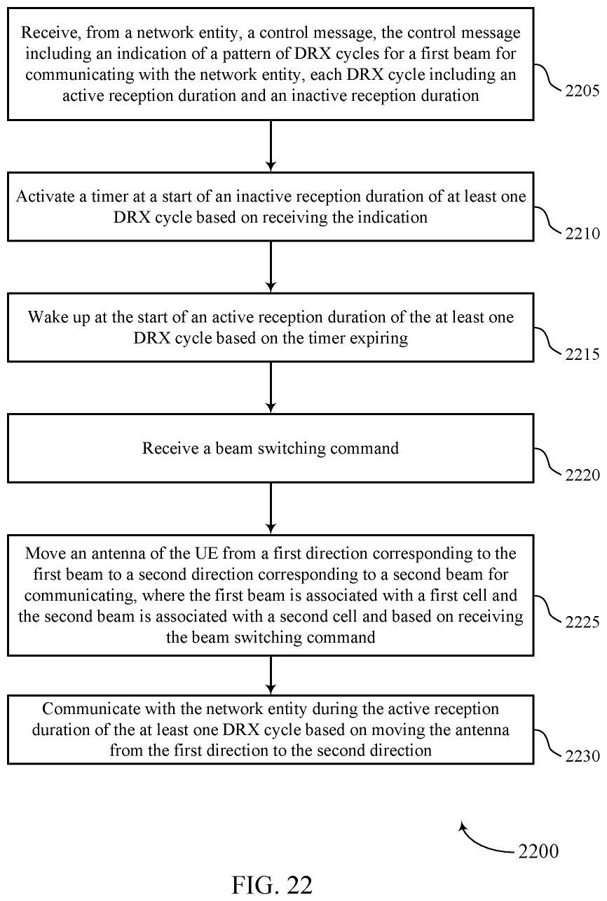

FIG. 22 shows a flowchart illustrating a method 2200 that supports satellite tracking related methods in accordance with aspects of the present disclosure. The operations of method 2200 may be implemented by a UE 115 or its components as described herein. For example, the operations of method 2200 may be performed by a communications manager as described with reference to FIGS. 9 through 12. In some examples, a UE may execute a set of instructions to control the functional elements of the UE to perform the functions described below. Additionally or alternatively, a UE may perform aspects of the functions described below using special-purpose hardware.

At 2205, the UE may receive, from a network entity, a control message, the control message including an indication of a pattern of DRX cycles for a first beam for communicating with the network entity, each DRX cycle including an active reception duration and an inactive reception duration. The operations of 2205 may be performed according to the methods described herein. In some examples, aspects of the operations of 2205 may be performed by a control message component as described with reference to FIGS. 9 through 12.

At 2210, the UE may activate the timer at a start of an inactive reception duration of the at least one DRX cycle based on receiving the indication. The operations of 2210 may be performed according to the methods described herein. In some examples, aspects of the operations of 2210 may be performed by a timer component as described with reference to FIGS. 9 through 12.

At 2215, the UE may wake up based on the timer expiring. The operations of 2215 may be performed according to the methods described herein. In some examples, aspects of the operations of 2215 may be performed by a timer component as described with reference to FIGS. 9 through 12.

At 2220, the UE may receive a beam switching command. The operations of 2220 may be performed according to the methods described herein. In some examples, aspects of the operations of 2220 may be performed by a timer component as described with reference to FIGS. 9 through 12.

At 2225, the UE may move an antenna of the UE from a first direction corresponding to the first beam to a second direction corresponding to a second beam for communicating, where the first beam is associated with a first cell and the second beam is associated with a second cell and where moving the antenna from the first direction to the second direction is based on receiving the beam switching command. The operations of 2225 may be performed according to the methods described herein. In some examples, aspects of the operations of 2225 may be performed by an antenna component as described with reference to FIGS. 9 through 12.

At 2230, the UE may communicate with the network entity during an active reception duration of at least one DRX cycle based on moving the antenna from the first direction to the second direction. The operations of 2230 may be performed according to the methods described herein. In some examples, aspects of the operations of 2230 may be performed by a DRX cycle component as described with reference to FIGS. 9 through 12.

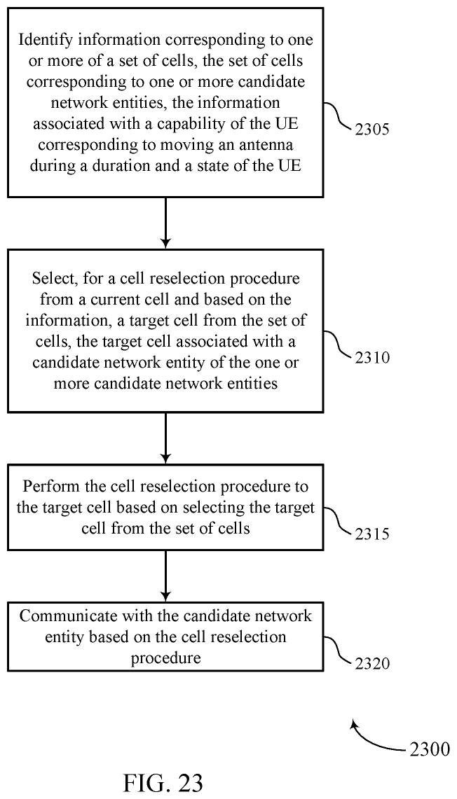

FIG. 23 shows a flowchart illustrating a method 2300 that supports satellite tracking related methods in accordance with aspects of the present disclosure. The operations of method 2300 may be implemented by a UE 115 or its components as described herein. For example, the operations of method 2300 may be performed by a communications manager as described with reference to FIGS. 9 through 12. In some examples, a UE may execute a set of instructions to control the functional elements of the UE to perform the functions described below. Additionally or alternatively, a UE may perform aspects of the functions described below using special-purpose hardware.

At 2305, the UE may identify information corresponding to one or more of a set of cells, the set of cells corresponding to one or more candidate network entities, the information associated with a capability of the UE corresponding to moving an antenna during a duration and a state of the UE. The operations of 2305 may be performed according to the methods described herein. In some examples, aspects of the operations of 2305 may be performed by a capability component as described with reference to FIGS. 9 through 12.

At 2310, the UE may select, for a cell reselection procedure from a current cell and based on the information, a target cell from the set of cells, the target cell associated with a candidate network entity of the one or more candidate network entities. The operations of 2310 may be performed according to the methods described herein. In some examples, aspects of the operations of 2310 may be performed by a target cell component as described with reference to FIGS. 9 through 12.

At 2315, the UE may perform the cell reselection procedure to the target cell based on selecting the target cell from the set of cells. The operations of 2315 may be performed according to the methods described herein. In some examples, aspects of the operations of 2315 may be performed by a cell reselection component as described with reference to FIGS. 9 through 12.

At 2320, the UE may communicate with the candidate network entity based on the cell reselection procedure. The operations of 2320 may be performed according to the methods described herein. In some examples, aspects of the operations of 2320 may be performed by a cell reselection component as described with reference to FIGS. 9 through 12.

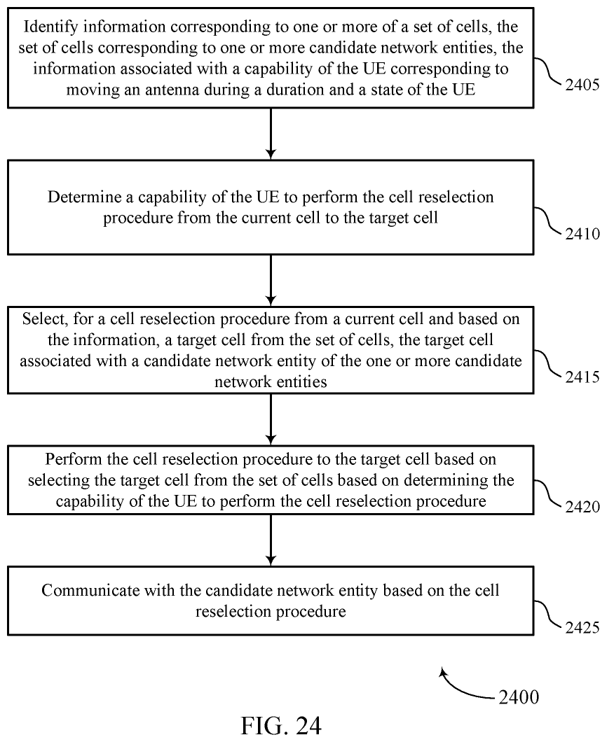

FIG. 24 shows a flowchart illustrating a method 2400 that supports satellite tracking related methods in accordance with aspects of the present disclosure. The operations of method 2400 may be implemented by a UE 115 or its components as described herein. For example, the operations of method 2400 may be performed by a communications manager as described with reference to FIGS. 9 through 12. In some examples, a UE may execute a set of instructions to control the functional elements of the UE to perform the functions described below. Additionally or alternatively, a UE may perform aspects of the functions described below using special-purpose hardware.

At 2405, the UE may identify information corresponding to one or more of a set of cells, the set of cells corresponding to one or more candidate network entities, the information associated with a capability of the UE corresponding to moving an antenna during a duration and a state of the UE. The operations of 2405 may be performed according to the methods described herein. In some examples, aspects of the operations of 2405 may be performed by a capability component as described with reference to FIGS. 9 through 12.

At 2410, the UE may determine a capability of the UE to perform the cell reselection procedure from the current cell to the target cell. The operations of 2410 may be performed according to the methods described herein. In some examples, aspects of the operations of 2410 may be performed by a capability component as described with reference to FIGS. 9 through 12.

At 2415, the UE may select, for a cell reselection procedure from a current cell and based on the information, a target cell from the set of cells, the target cell associated with a candidate network entity of the one or more candidate network entities, where performing the cell reselection procedure is based on determining the capability of the UE to perform the cell reselection procedure. The operations of 2415 may be performed according to the methods described herein. In some examples, aspects of the operations of 2415 may be performed by a target cell component as described with reference to FIGS. 9 through 12.

At 2420, the UE may perform the cell reselection procedure to the target cell based on selecting the target cell from the set of cells. The operations of 2420 may be performed according to the methods described herein. In some examples, aspects of the operations of 2420 may be performed by a cell reselection component as described with reference to FIGS. 9 through 12.

At 2425, the UE may communicate with the candidate network entity based on the cell reselection procedure. The operations of 2425 may be performed according to the methods described herein. In some examples, aspects of the operations of 2425 may be performed by a cell reselection component as described with reference to FIGS. 9 through 12.

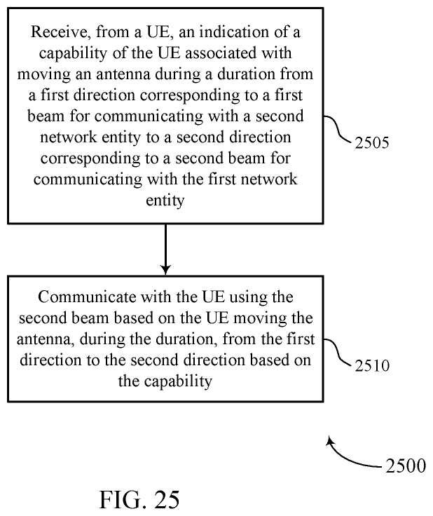

FIG. 25 shows a flowchart illustrating a method 2500 that supports satellite tracking related methods in accordance with aspects of the present disclosure. The operations of method 2500 may be implemented by a network entity or its components as described herein. For example, the operations of method 2500 may be performed by a communications manager as described with reference to FIGS. 13 through 16. In some examples, a network entity may execute a set of instructions to control the functional elements of the network entity to perform the functions described below. Additionally or alternatively, a network entity may perform aspects of the functions described below using special-purpose hardware.

At 2505, the network entity may receive, from a UE, an indication of a capability of the UE associated with moving an antenna during a duration from a first direction corresponding to a first beam for communicating with a second network entity to a second direction corresponding to a second beam for communicating with the first network entity. The operations of 2505 may be performed according to the methods described herein. In some examples, aspects of the operations of 2505 may be performed by a capability component as described with reference to FIGS. 13 through 16.

At 2510, the network entity may communicate with the UE using the second beam based on the UE moving the antenna, during the duration, from the first direction to the second direction based on the capability. The operations of 2510 may be performed according to the methods described herein. In some examples, aspects of the operations of 2510 may be performed by an antenna component as described with reference to FIGS. 13 through 16.

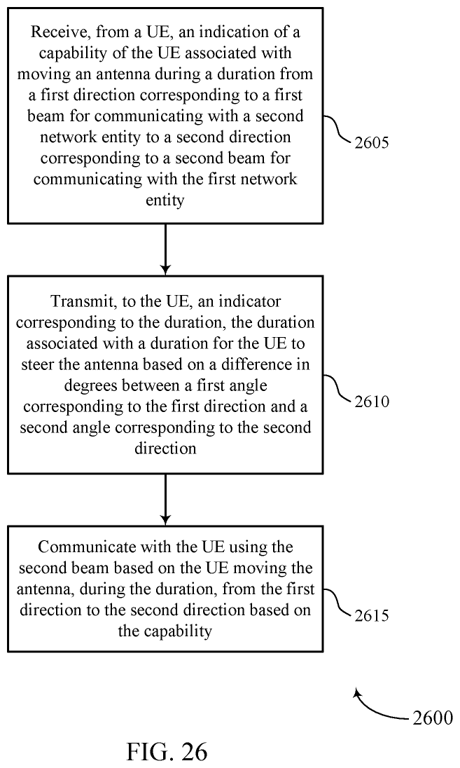

FIG. 26 shows a flowchart illustrating a method 2600 that supports satellite tracking related methods in accordance with aspects of the present disclosure. The operations of method 2600 may be implemented by a network entity or its components as described herein. For example, the operations of method 2600 may be performed by a communications manager as described with reference to FIGS. 13 through 16. In some examples, a network entity may execute a set of instructions to control the functional elements of the network entity to perform the functions described below. Additionally or alternatively, a network entity may perform aspects of the functions described below using special-purpose hardware.

At 2605, the network entity may receive, from a UE, an indication of a capability of the UE associated with moving an antenna during a duration from a first direction corresponding to a first beam for communicating with a second network entity to a second direction corresponding to a second beam for communicating with the first network entity. The operations of 2605 may be performed according to the methods described herein. In some examples, aspects of the operations of 2605 may be performed by a capability component as described with reference to FIGS. 13 through 16.

At 2610, the network entity may transmit, to the UE, an indicator corresponding to the duration, the duration associated with a duration for the UE to steer the antenna based on a difference in degrees between a first angle corresponding to the first direction and a second angle corresponding to the second direction. The operations of 2610 may be performed according to the methods described herein. In some examples, aspects of the operations of 2610 may be performed by a direction component as described with reference to FIGS. 13 through 16.

At 2615, the network entity may communicate with the UE using the second beam based on the UE moving the antenna, during the duration, from the first direction to the second direction based on the capability. The operations of 2615 may be performed according to the methods described herein. In some examples, aspects of the operations of 2615 may be performed by an antenna component as described with reference to FIGS. 13 through 16.

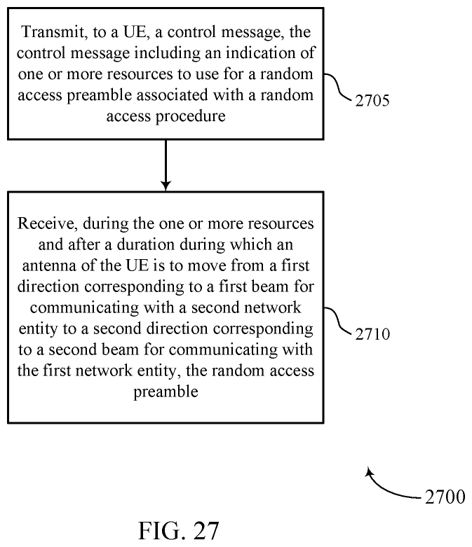

FIG. 27 shows a flowchart illustrating a method 2700 that supports satellite tracking related methods in accordance with aspects of the present disclosure. The operations of method 2700 may be implemented by a network entity or its components as described herein. For example, the operations of method 2700 may be performed by a communications manager as described with reference to FIGS. 13 through 16. In some examples, a network entity may execute a set of instructions to control the functional elements of the network entity to perform the functions described below. Additionally or alternatively, a network entity may perform aspects of the functions described below using special-purpose hardware.

At 2705, the network entity may transmit, to a UE, a control message, the control message including an indication of one or more resources to use for a random access preamble associated with a random access procedure. The operations of 2705 may be performed according to the methods described herein. In some examples, aspects of the operations of 2705 may be performed by a resources component as described with reference to FIGS. 13 through 16.

At 2710, the network entity may receive, during the one or more resources and after a duration during which an antenna of the UE is to move from a first direction corresponding to a first beam for communicating with a second network entity to a second direction corresponding to a second beam for communicating with the first network entity, the random access preamble. The operations of 2710 may be performed according to the methods described herein. In some examples, aspects of the operations of 2710 may be performed by a direction component as described with reference to FIGS. 13 through 16.

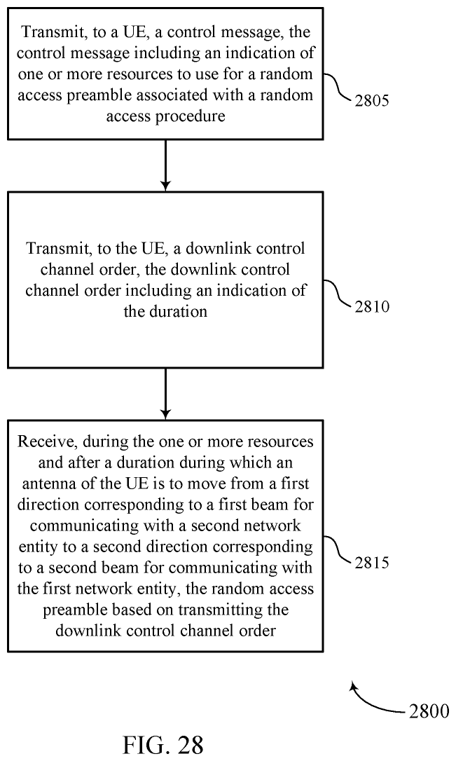

FIG. 28 shows a flowchart illustrating a method 2800 that supports satellite tracking related methods in accordance with aspects of the present disclosure. The operations of method 2800 may be implemented by a network entity or its components as described herein. For example, the operations of method 2800 may be performed by a communications manager as described with reference to FIGS. 13 through 16. In some examples, a network entity may execute a set of instructions to control the functional elements of the network entity to perform the functions described below. Additionally or alternatively, a network entity may perform aspects of the functions described below using special-purpose hardware.

At 2805, the network entity may transmit, to a UE, a control message, the control message including an indication of one or more resources to use for a random access preamble associated with a random access procedure. The operations of 2805 may be performed according to the methods described herein. In some examples, aspects of the operations of 2805 may be performed by a resources component as described with reference to FIGS. 13 through 16.

At 2810, the network entity may transmit, to the UE, a downlink control channel order, the downlink control channel order including an indication of the duration. The operations of 2810 may be performed according to the methods described herein. In some examples, aspects of the operations of 2810 may be performed by a duration component as described with reference to FIGS. 13 through 16.

At 2815, the network entity may receive, during the one or more resources and after a duration during which an antenna of the UE is to move from a first direction corresponding to a first beam for communicating with a second network entity to a second direction corresponding to a second beam for communicating with the first network entity, the random access preamble, where receiving the random access preamble after the duration is based on transmitting the downlink control channel order. The operations of 2815 may be performed according to the methods described herein. In some examples, aspects of the operations of 2815 may be performed by a direction component as described with reference to FIGS. 13 through 16.

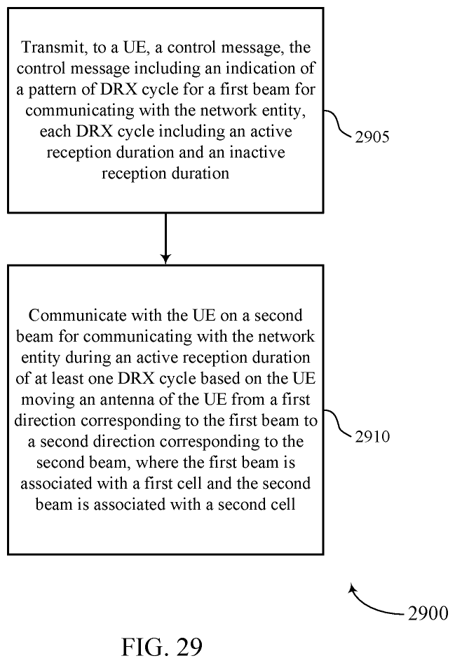

FIG. 29 shows a flowchart illustrating a method 2900 that supports satellite tracking related methods in accordance with aspects of the present disclosure. The operations of method 2900 may be implemented by a network entity or its components as described herein. For example, the operations of method 2900 may be performed by a communications manager as described with reference to FIGS. 13 through 16. In some examples, a network entity may execute a set of instructions to control the functional elements of the network entity to perform the functions described below. Additionally or alternatively, a network entity may perform aspects of the functions described below using special-purpose hardware.

At 2905, the network entity may transmit, to a UE, a control message, the control message including an indication of a pattern of DRX cycle for a first beam for communicating with the network entity, each DRX cycle including an active reception duration and an inactive reception duration. The operations of 2905 may be performed according to the methods described herein. In some examples, aspects of the operations of 2905 may be performed by a control message component as described with reference to FIGS. 13 through 16.

At 2910, the network entity may communicate with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell. The operations of 2910 may be performed according to the methods described herein. In some examples, aspects of the operations of 2910 may be performed by a DRX cycle component as described with reference to FIGS. 13 through 16.

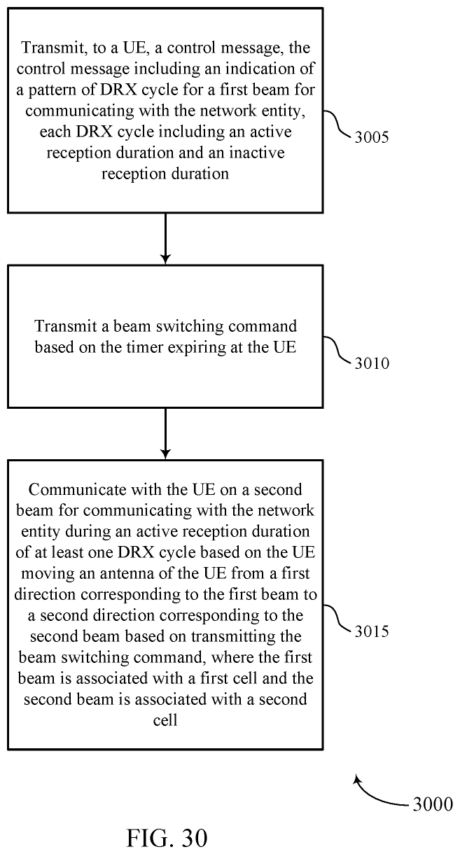

FIG. 30 shows a flowchart illustrating a method 3000 that supports satellite tracking related methods in accordance with aspects of the present disclosure. The operations of method 3000 may be implemented by a network entity or its components as described herein. For example, the operations of method 3000 may be performed by a communications manager as described with reference to FIGS. 13 through 16. In some examples, a network entity may execute a set of instructions to control the functional elements of the network entity to perform the functions described below. Additionally or alternatively, a network entity may perform aspects of the functions described below using special-purpose hardware.

At 3005, the network entity may transmit, to a UE, a control message, the control message including an indication of a pattern of DRX cycle for a first beam for communicating with the network entity, each DRX cycle including an active reception duration and an inactive reception duration. The operations of 3005 may be performed according to the methods described herein. In some examples, aspects of the operations of 3005 may be performed by a control message component as described with reference to FIGS. 13 through 16.

At 3010, the network entity may transmit a beam switching command based on the timer expiring at the UE. The operations of 3010 may be performed according to the methods described herein. In some examples, aspects of the operations of 3010 may be performed by a timer component as described with reference to FIGS. 13 through 16.

At 3015, the network entity may communicate with the UE on a second beam for communicating with the network entity during an active reception duration of at least one DRX cycle based on the UE moving an antenna of the UE from a first direction corresponding to the first beam to a second direction corresponding to the second beam, where the first beam is associated with a first cell and the second beam is associated with a second cell and where the UE moves the antenna from the first direction to the second direction based on transmitting the beam switching command. The operations of 3015 may be performed according to the methods described herein. In some examples, aspects of the operations of 3015 may be performed by a DRX cycle component as described with reference to FIGS. 13 through 16.

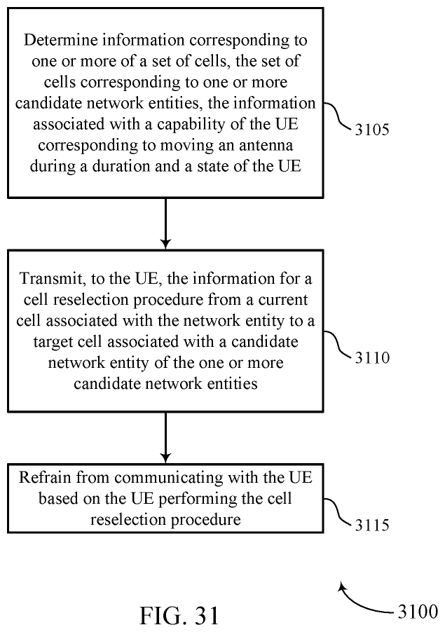

FIG. 31 shows a flowchart illustrating a method 3100 that supports satellite tracking related methods in accordance with aspects of the present disclosure. The operations of method 3100 may be implemented by a network entity or its components as described herein. For example, the operations of method 3100 may be performed by a communications manager as described with reference to FIGS. 13 through 16. In some examples, a network entity may execute a set of instructions to control the functional elements of the network entity to perform the functions described below. Additionally or alternatively, a network entity may perform aspects of the functions described below using special-purpose hardware.

At 3105, the network entity may determine information corresponding to one or more of a set of cells, the set of cells corresponding to one or more candidate network entities, the information associated with a capability of the UE corresponding to moving an antenna during a duration and a state of the UE. The operations of 3105 may be performed according to the methods described herein. In some examples, aspects of the operations of 3105 may be performed by a capability component as described with reference to FIGS. 13 through 16.

At 3110, the network entity may transmit, to the UE, the information for a cell reselection procedure from a current cell associated with the network entity to a target cell associated with a candidate network entity of the one or more candidate network entities. The operations of 3110 may be performed according to the methods described herein. In some examples, aspects of the operations of 3110 may be performed by a target cell component as described with reference to FIGS. 13 through 16.

At 3115, the network entity may refrain from communicating with the UE based on the UE performing the cell reselection procedure. The operations of 3115 may be performed according to the methods described herein. In some examples, aspects of the operations of 3115 may be performed by a cell reselection component as described with reference to FIGS. 13 through 16.

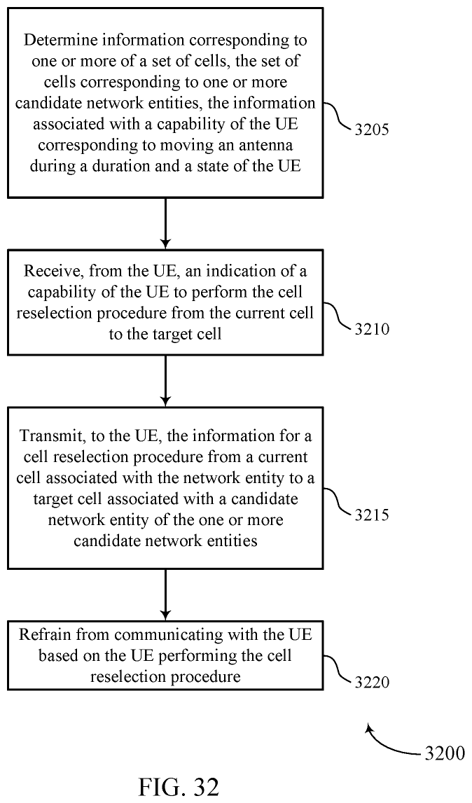

FIG. 32 shows a flowchart illustrating a method 3200 that supports satellite tracking related methods in accordance with aspects of the present disclosure. The operations of method 3200 may be implemented by a network entity or its components as described herein. For example, the operations of method 3200 may be performed by a communications manager as described with reference to FIGS. 13 through 16. In some examples, a network entity may execute a set of instructions to control the functional elements of the network entity to perform the functions described below. Additionally or alternatively, a network entity may perform aspects of the functions described below using special-purpose hardware.

At 3205, the network entity may determine information corresponding to one or more of a set of cells, the set of cells corresponding to one or more candidate network entities, the information associated with a capability of the UE corresponding to moving an antenna during a duration and a state of the UE. The operations of 3205 may be performed according to the methods described herein. In some examples, aspects of the operations of 3205 may be performed by a capability component as described with reference to FIGS. 13 through 16.

At 3210, the network entity may receive, from the UE, an indication of a capability of the UE to perform the cell reselection procedure from the current cell to the target cell. The operations of 3210 may be performed according to the methods described herein. In some examples, aspects of the operations of 3210 may be performed by a capability component as described with reference to FIGS. 13 through 16.

At 3215, the network entity may transmit, to the UE, the information for a cell reselection procedure from a current cell associated with the network entity to a target cell associated with a candidate network entity of the one or more candidate network entities. The operations of 3215 may be performed according to the methods described herein. In some examples, aspects of the operations of 3215 may be performed by a target cell component as described with reference to FIGS. 13 through 16.

At 3220, the network entity may refrain from communicating with the UE based on the UE performing the cell reselection procedure. The operations of 3220 may be performed according to the methods described herein. In some examples, aspects of the operations of 3220 may be performed by a cell reselection component as described with reference to FIGS. 13 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as any combination of computing devices (e.g., any combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a user equipment (UE), comprising:
determining a capability of the UE associated with moving an antenna during a duration from a first direction corresponding to a first beam for communicating with a network entity to a second direction corresponding to a second beam for communicating;
transmitting, to the network entity, an indication of the capability associated with moving the antenna during the duration from the first direction to the second direction; and
moving the antenna, during the duration, from the first direction to the second direction based at least in part on transmitting the indication of the capability.

2. The method of claim 1, wherein determining the capability of the UE associated with moving the antenna comprises:
receiving an indication corresponding to the duration, the duration associated with a duration for the UE to steer the antenna based on a difference in one or more degrees between a first angle corresponding to the first direction and a second angle corresponding to the second direction.

3. The method of claim 1, wherein determining the capability of the UE associated with moving the antenna comprises:
determining an antenna type associated with the antenna, a number of antennas at the UE, a continuous tracking mode associated with the antenna, a step-wise tracking mode associated with the antenna, or any combination thereof.

4. The method of claim 1, further comprising:
determining to perform a change of association procedure from the network entity to a target network entity, wherein the second beam is for communicating with the target network entity; and
communicating with the target network entity based at least in part on moving the antenna from the first direction to the second direction.

5. The method of claim 4, wherein the change of association procedure is a handover between two cells.

6. The method of claim 4, wherein the change of association procedure is a beam switching operation within a same cell.

7. The method of claim 1, wherein the antenna is an active electronically scanned array or a mechanical motor steered antenna.

8. The method of claim 1, wherein the UE and the network entity are associated with a non-terrestrial network, and wherein the network entity is a satellite.

9. A method for wireless communications at a user equipment (UE), comprising:
receiving, from a network entity, a control message, the control message comprising an indication of one or more resources to use for a random access preamble associated with a random access procedure;
determining, based at least in part on receiving the control message, a duration during which an antenna of the UE is to move from a first direction corresponding to a first beam for communicating with the network entity to a second direction corresponding to a second beam for communicating; and
transmitting, after the duration, the random access preamble using the one or more resources.

10. The method of claim 9, further comprising:
determining to perform a change of association procedure from the network entity to a target network entity, wherein the second beam is for communicating with the target network entity.

11. (canceled)

12. (canceled)

13. The method of claim 10, wherein receiving the control message comprises;
receiving an indication of the target network entity, the indication comprising location information of the target network entity, an identifier corresponding to the target network entity, or both.

14. The method of claim 10, wherein transmitting the random access preamble comprises:
transmitting the random access preamble to the target network entity as part of the handover procedure, wherein the second beam is for communicating with the target network entity.

15. The method of claim 9, further comprising:
receiving, from the network entity, a downlink control channel order, the downlink control channel order comprising an indication of the duration, wherein transmitting the random access preamble after the duration is based at least in part on receiving the downlink control channel order.

16. The method of claim 15, receiving the downlink control channel order comprises:
receiving a downlink control information message, a medium access control-control element, or both, the downlink control information message, the medium access control-control element, or both comprising an index corresponding to the random access preamble, an indication of one or more random access occasions, or both.

17. The method of claim 15, wherein transmitting the random access preamble comprises:
determining an additional duration, the additional duration comprising an uplink channel preparation time, a bandwidth part switching duration, an operational frequency range duration, or any combination thereof; and
transmitting the random access preamble based at least in part on the duration and the additional duration.

18. The method of claim 17, further comprising:
determining a given duration based at least in part on a capability of the UE to move the antenna of the UE and transmit the random access preamble concurrently; and
transmitting the random access preamble after the given duration, wherein the given duration corresponds to the shorter of the duration and the additional duration.

19. The method of claim 17, further comprising:
transmitting the random access preamble after the duration and the additional duration.

20. The method of claim 9, wherein receiving the control message comprises:
receiving an indication of the duration, the duration corresponding to a handover outage time, a duration for the UE to apply frequency compensation, a duration for frequency retuning, or any combination thereof.

21. (canceled)

22. The method of claim 20, further comprising:
initiating a timer based at least in part on receiving the indication, the timer duration corresponding to the duration; and
transmitting the random access preamble based at least in part on the timer duration.

23. (canceled)

24. The method of claim 9, further comprising:
determining the duration based at least in part on a handover outage time, a duration for the UE to apply frequency compensation, a duration for frequency retuning, or any combination thereof.

25. The method of claim 24, further comprising:
determining the handover outage time based at least in part on ephemeris information associated with one or more network entities, a capability of the UE associated with moving the antenna, or any combination thereof.

26. The method of claim 9, wherein receiving the control message comprising the indication of one or more resources comprises:
receiving an index corresponding to the random access preamble, one or more random access occasions for transmitting the random access preamble, or any combination thereof.

27. (canceled)

28. A method for wireless communications at a user equipment (UE), comprising:
receiving, from a network entity, a control message, the control message comprising an indication of a pattern of discontinuous reception cycles for a first beam for communicating with the network entity, each discontinuous reception cycle comprising an active reception duration and an inactive reception duration:
moving an antenna of the UE from a first direction corresponding to the first beam to a second direction corresponding to a second beam for communicating, wherein the first beam is associated with a first cell and the second beam is associated with a second cell; and
communicating with the network entity during an active reception duration of at least one discontinuous reception cycle based at least in part on moving the antenna from the first direction to the second direction.

29. The method of claim 28, wherein the control message comprises an indication of a timer, the method further comprising:
activating the timer at a start of an inactive reception duration of the at least one discontinuous reception cycle based at least in part on receiving the indication;
waking up at the start of the active reception duration of the at least one discontinuous reception cycle based at least in part on the timer expiring; and
receiving a beam switching command, wherein moving the antenna from the first direction to the second direction is based at least in part on receiving the beam switching command.

30. The method of claim 29, further comprising:
transmitting, to the network entity, a feedback message corresponding to receiving the beam switching command.

31. The method of claim 29, further comprising:
performing a beam switching operation from a first bandwidth part associated with the first beam to a second bandwidth part associated with the second beam based at least in part on receiving the beam switching command.

32. The method of claim 29, wherein the timer corresponds to a handover outage time, a duration for the UE to apply frequency compensation, a duration for frequency retuning, or any combination thereof.

33. The method of claim 28, wherein the control message comprises an indication of a timer, the method further comprising:
activating the timer after receiving the control message;
waking up based at least in part on the timer expiring; and
determining to perform a change of association procedure based at least in part on the first cell being different than the second cell.

34. The method of claim 33, further comprising:
transmitting, to a network entity associated with the second beam, an indication of the change of associated procedure, wherein the indication comprises a random access preamble, a scheduling request, or both.

35. The method of claim 33, wherein the change of association procedure is a handover procedure from a current cell associated with the network entity to a target cell associated with a target network entity, wherein the second beam is for communicating with the target network entity.

36. The method of claim 33, wherein the timer corresponds to a duration for the UE to enter a coverage area associated with the second beam, a handover outage time, a duration for the UE to apply frequency compensation, a duration for frequency retuning, or any combination thereof.

37. (canceled)

38. (canceled)

39. A method for wireless communications at a user equipment (UE), comprising:
identifying information corresponding to one or more of a plurality of cells, the plurality of cells corresponding to one or more candidate network entities, the information associated with a capability of the UE corresponding to moving an antenna during a duration and a state of the UE;
selecting, for a cell reselection procedure from a current cell and based at least in part on the information, a target cell from the plurality of cells, the target cell associated with a candidate network entity of the one or more candidate network entities;
performing the cell reselection procedure to the target cell based at least in part on selecting the target cell from the plurality of cells; and
communicating with the candidate network entity based at least in part on the cell reselection procedure.

40. The method of claim 39, further comprising:
receiving, from a network entity, an indication of a cell identifier for each cell of the plurality of cells, location information corresponding to the one or more candidate network entities, relative speed information corresponding to the one or more candidate network entities, orbital information corresponding to the one or more candidate network entities, a random access preamble for each cell of the plurality of cells, a priority associated with the one or more candidate network entities, or any combination thereof, wherein identifying the information is based at least in part on the receiving.

41. The method of claim 39, further comprising:
determining a capability of the UE to perform the cell reselection procedure from the current cell to the target cell, wherein performing the cell reselection procedure is based at least in part on determining the capability of the UE to perform the cell reselection procedure.

42. (canceled)

43. A method for wireless communications at a first network entity, comprising:
receiving, from a user equipment (UE), an indication of a capability of the UE associated with moving an antenna during a duration from a first direction corresponding to a first beam for communicating with a second network entity to a second direction corresponding to a second beam for communicating with the first network entity; and communicating with the UE using the second beam based at least in part on the UE moving the antenna, during the duration, from the first direction to the second direction based at least in part on the capability.

44-239. (canceled)
